(19) United States
(12) Patent Application Publication
(10) Pub. No.: US 2025/0324341 A1
(43) Pub. Date: Oct. 16, 2025

(54) FIRST NODE, SECOND NODE AND METHODS PERFORMED THEREBY FOR HANDLING EXPOSURE TO AN EVENT FOR A DEVICE

(71) Applicant: Telefonaktiebolaget LM Ericsson (publ), Stockholm (SE)

(72) Inventors: David CASTELLANOS ZAMORA, Madrid (ES); Emiliano MERINO, Madrid (ES)

(21) Appl. No.: 18/865,407

(22) PCT Filed: Jun. 27, 2022
(86) PCT No.: PCT/EP2022/067543

§ 371 Date: Nov. 13, 2024

(30) Foreign Application Priority Data
May 20, 2022 (EP) 22382487.1

(51) Int. Cl. H04W 36/32; H04L 41/5009; H04W 12/06

(52) U.S. Cl. CPC H04W 36/322; H04L 41/5009; H04W 12/06

(57) ABSTRACT

A computer-implemented method, performed by a first node. The method is for handling exposure to an event for a device. The first node operates in a first communications network, a home network to the device and to a second node. The first node determines whether a third node operating via the first communications network has permission to receive notifications of the event while the device is roaming in a second communications network. The determining is based on one or more agreements of the third node with the first communications network to service the device in one or more roaming communications networks. The first node sends second indication to the second node operating in the first communications network. The second indication indicates a result of the determination.

### TECHNICAL FIELD

The present disclosure relates generally to a first node and methods performed thereby for exposure to an event for a device. The present disclosure also relates generally to a second node, and methods performed thereby for handling exposure to the event for the device.

### BACKGROUND

Computer systems in a communications network or communications system may comprise one or more nodes. A node may comprise one or more processors which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. In case the AF may be trusted, e.g., internal to the network operator, the AF may interact with the 3GPP Core Network directly, with no NEF involved. The NEF 2 may support different functionality, e.g., different Exposure Application Program Interfaces (APIs), e.g., sponsored Data, Quality of Service (QOS), etc., which may allow a content provider to request policies from the Mobile Network Operator (MNO). A Unified Data Repository (UDR), which is not depicted, may store data grouped into distinct collections of subscription-related information: subscription data, policy data, structured data for exposure, and application data. A Unified Data Management Function (UDM) 3 may generate 3GPP 5G AKA Authentication Vectors, handle user identification handling, support a UE's Serving NF Registration Management, e.g., storing the serving Access and Mobility Function (AMF) for a UE, storing the serving Session Management Function (SMF) for a UE's Packet Data Unit (PDU) Session, etc., support retrieval of the UE's individual subscription data for slice selection, and handle subscription data for network exposure capabilities applicable to an individual UE or a group of UEs. A Policy Control Function (PCF) 4 may support a unified policy framework to govern the network behavior. Specifically, the PCF 4 may provide Policy and Charging Control (PCC) rules to the Policy and Charging Enforcement Function (PCEF), that is, an SMF 5/User Plane function (UPF) 6 that may enforce policy and charging decisions according to provisioned Policy and Charging Control (PCC) rules. The SMF 5 may support different functionalities, e.g., session establishment, modify and release, and policy related functionalities such as termination of interfaces towards policy control functions, charging data collection, support of charging interfaces and control and coordination of charging data collection at the UPF 6. Specifically, the SMF 5 may receive the PCC rules from the PCF 4 and may configure the UPF 6 accordingly through an N4 7 reference point, Packet Flow Control Protocol (PFCP) protocol. The UPF 6 may support handling of user plane traffic based on the rules received from the SMF 5, e.g., packet inspection through Packet Detection Rules (PDRs) and different enforcement actions such as, e.g., traffic steering, QOS, Charging/Reporting through Forwarding Action Rules (FARs), QoS Enforcement Rules (QERs), and/or Usage Reporting Rule (URRs). The PCF 4 may provide policy rules to a UE 8 through the AMF 9. The AMF 9 may manage access of the UE 8, for example, when the UE 8 may be connected through different access networks, and mobility aspects of the UE 8. Also depicted in FIG. 1 is a Network Slice Selection Function (NSSF) 10, Network Repository Function (NRF) 11, an Authentication Server Function (AUSF) 12, a Radio Access Network (RAN) 13, and a Data Network (DN) 14. Each of the NSSF 10, the NEF 2, the NRF 11, the PCF 4, the UDM 3, the AF 1, the AUSF 12, the AMF 9, the SMF 5, the UE 8, the RAN 13, the UPF 6 and the DN 14 may have an interface through which they may be accessed, which as depicted in the Figure, may be, respectively: Nnssf 15, Nnef 16, Nnrf 17, Npcf 18, Nudm 19, Naf 20, Nausf 21, Namf 22, Nsmf 23, N1 24, and N2 25. The RAN 13 may have an interface N3 26 with the UPF 6, and the UPF 6 may have an interface N6 27 with the DN 14.

During the course of communications in a communications network, UEs may roam out of their Home Public Land Mobile Network (HPLMN) into one or more other Visiting Public Land Mobile Networks (VPLMNs). These roaming UEs may continue to wish to be serviced by one or more applications, which in turn wish to monitor one or more events concerning the UEs. An event may be understood to be an occurrence in a communications network specific for a UE, such as e.g., UE location, reachability, roaming status changes and/or loss of connectivity. In order to receive a notification about an event, an application may need to send a request for exposure to such event. Exposure may be understood to refer to enabling the use of capabilities of network functions, e.g., monitoring capabilities, to applications external to the HPLMN.

In a 5G network, in order to allow exposure requests for outbound roamers, as long as a UE may be allowed to attach/register in the VPLMNs, a UDM may, as described in the 3GPP Technical Specification (TS) 23.502, version 17.4.0, clause 4.15.3.2.2, send a Namf_EventExposure_Subscribe request to all serving AMF(s), in the HPLMN and in the VPLMN, if subscription applies to the UE or a group of UE(s). According to this, the UDM may contact the AMF without any further check of whether the UE may be in a VPLMN, as long as the UE subscription data may allow the UE to be a roamer.

In Evolved Packet Core (EPC)/Fourth Generation (4G) networks, this may be the responsibility of the serving node, e.g., the Mobility Management Entity (MME)/or the AMF. According to TS 23.682, version 17.4.0, the MME/Serving General Packet Radio Service Support Node (SGSN) may verify a request for exposure to a certain event, to check e.g., if the type of monitoring, that is, the Monitoring Type, may be covered by a roaming agreement when the request may be from another Public Land Mobile Network (PLMN).

One or more agreements may specify the one or more services that a particular communications network may offer to any wireless device, e.g., UE, that may register or attach to it. Each of these agreements may be also referred to as a Service Level Agreement.

It may be then assumed that, in 5GC, the responsibility to allow exposure requests for inbound roamers based on Service Level Agreements (SLAs) may be understood to be for the AMF in the VPLMN.

This roaming agreement for exposure traffic of outbound roamers may be also required. According to 3GPP TS 23.502, version 17.4.0, to support monitoring features in roaming scenarios, a roaming agreement may need to be made between the Home Public Land Mobile Network (HPLMN) and the VPLMN.

Existing methods for handling exposure to events in roaming scenarios may involve high overhead and high latency and, as a result, impair the effective functioning of the communications networks involved.

### SUMMARY

As part of the development of embodiments herein, one or more challenges with the existing technology will first be identified and discussed.

If a roaming UE is not allowed to register in a VPLMN, that is, if the UE has roaming disallowed, while a monitoring event may be ongoing for the UE, the corresponding AF may be informed about it, e.g., by a “ROAMING_NOT_ALLOWED”. However, if regardless of the UEs being allowed to register in their VPLMNs, an operator does not wish to allow exposure information for certain applications, it is currently not possible to apply specific exposure enforcement for roaming scenarios.

According to existing methods, if the UE is a roamer, that is, if it is attached in a visited PLMN/country instead of the home PLMN, the event(s) may be sent to AMF in the visited network, requesting the VPLMN to create UE context resources and report events with no difference when compared to the UE being in the home PLMN, regardless of whether the VPLMN may allow exposure requests for inbound roamers, or if the VPLMN may support exposure in the first place.

Hence, the AMF in the visiting network may need to enforce this authorization for event exposure for inbound roamers registering in its network. This may be understood to be quite inefficient, since it may imply that a request for exposure to the event may be rejected at the VPLMN Network Function (NF), which may have to detect and report the event, e.g., the last NF in the signaling chain. In the context of 5GC, the request may be sent by the UDM in the home network and may have to traverse multiple NFs: UDM in the home network->Service Communication Proxy (SCP) (HPLMN)->Security Edge Protection Proxy (SEPP) (HPLMN)->SEPP (VPLMN)->SCP (VPLMN)->AMF (VPLMN), only to potentially be rejected after reaching the last node. This may be understood to result in signalling overhead and latency, in addition to computing resources for the nodes involved.

According to the foregoing, it is an object of embodiments herein to improve the handling of exposure to an event for a device in a communications system.

According to a first aspect of embodiments herein, the object is achieved by a computer-implemented method, performed by a first node. The method is for handling exposure to an event for a device. The first node operates in a first communications network. The first communications network is a home network to the device and to a second node. The first node determines whether or not a third node operating in a communications system via the first communications network has permission to receive notifications of the event while the device is roaming in a second communications network. The determining is performed in response to a first indication received from the third node. The first indication indicates a request to receive a notification of the event for the device. The determining is based on one or more agreements of the third node with the first communications network to service the device in one or more roaming communications networks. The first node also sends a second indication to the second node operating in the first communications network. The second indication indicates a result of the determination.

According to a second aspect of embodiments herein, the object is achieved by a computer-implemented method, performed by the second node. The method is for handling exposure to the event for the device. The second node operates in the first communications network. The first communications network is the home network to the device. The second node receives the second indication from the first node operating in the first communications network. The second indication indicates whether or not the third node operating in the communications system via the first communications network has permission to receive notifications of the event while the device is roaming in the second communications network. The second indication is based on the one or more agreements of the third node with the first communications network to service the device in one or more roaming communications networks. The second node also sends a third indication to the first node. The third indication indicates whether or not the device is roaming. The third indication is based on the sent second indication.

According to a third aspect of embodiments herein, the object is achieved by the first node, for handling exposure to the event for the device. The first node is configured to operate in the first communications network. The first communications network is configured to be the home network to the device and to the second node. The first node is further configured to determine whether or not the third node configured to operate in the communications system via the first communications network has permission to receive notifications of the event while the device is roaming in the second communications network. The determining is configured to be performed in response to the first indication configured to be received from the third node. The first indication is configured to indicate the request to receive the notification of the event for the device. The determining is configured to be based on the one or more agreements of the third node with the first communications network to service the device in the one or more roaming communications networks. The first node is further configured to send the second indication to the second node configured to operate in the first communications network. The second indication is configured to indicate the result of the determination.

According to a fourth aspect of embodiments herein, the object is achieved by the second node, for handling exposure to the event for the device. The second node is configured to operate in the first communications network. The first communications network is configured to be the home network to the device. The second node is further configured to receive the second indication from the first node configured to operate in the first communications network. The second indication is configured to indicate whether or not the third node configured to operate in the communications system via the first communications network has permission to receive notifications of the event while the device is roaming in the second communications network. The second indication is configured to operate based on the one or more agreements of the third node with the first communications network to service the device in the one or more roaming communications networks. The second node is further configured to send the third indication to the first node. The third indication is configured to indicate whether or not the device is roaming. The third indication is configured to be based on the second indication configured to be sent.

By determining whether or not the third node has permission to receive the notifications of the event based on the one or more agreements, the first node may be enabled to act accordingly within the first communications network and avoid that requests to receive the notifications may be sent over to a communications network where the third node may not have permission to receive them anyway. That is, whether exposure information may be enabled for outbound roaming devices may be enforced, according to embodiments herein, at the home network instead of at the visiting network, thereby avoiding unnecessary signalling overhead.

By then sending the second indication to the second node, the first node may enable that the second node may only contact a serving node if the device is in a communications network wherein, according to the one or more agreements, it may have permission to receive notifications of the event while roaming, or if the device may be located in the first communications network. Since the exposure information may be disallowed, that is, the decision to disallow it may be taken, in the home network, and not in the visiting network, signalling overhead may be allowed to be saved and latency may be allowed to be reduced in the service to the device, thereby, enabling to improve the performance of the communications system.

By the second node then sending the third indication to the first node indicating whether or not the device is roaming, the first node may be enabled to act accordingly, and e.g., let the third node know that the notification may, or may not be received, according to the one or more agreements.

### BRIEF DESCRIPTION OF THE DRAWINGS

Examples of embodiments herein are described in more detail with reference to the accompanying drawings, according to the following description.

FIG. 1 is a schematic diagram illustrating an example of a 5G Network Architecture, according to existing methods.

FIG. 2 is a schematic diagram illustrating a non-limiting example of a communications system, according to embodiments herein.

FIG. 3 is a flowchart depicting embodiments of a method in a first node, according to embodiments herein.

FIG. 4 is a flowchart depicting embodiments of a method in a second node, according to embodiments herein.

FIG. 5 is a schematic diagram depicting a non-limiting example of signalling between nodes in a communications system, according to embodiments herein.

FIG. 6 is a schematic diagram depicting another non-limiting example of signalling between nodes in a communications system, according to embodiments herein.

FIG. 7 is a schematic diagram depicting yet another non-limiting example of signalling between nodes in a communications system, according to embodiments herein.

FIG. 8 is a schematic diagram depicting a further non-limiting example of signalling between nodes in a communications system, according to embodiments herein.

FIG. 9 is a schematic block diagram illustrating two non-limiting examples, a) and b), of a first node, according to embodiments herein.

FIG. 10 is a schematic block diagram illustrating two non-limiting examples, a) and b), of a second node, according to embodiments herein.

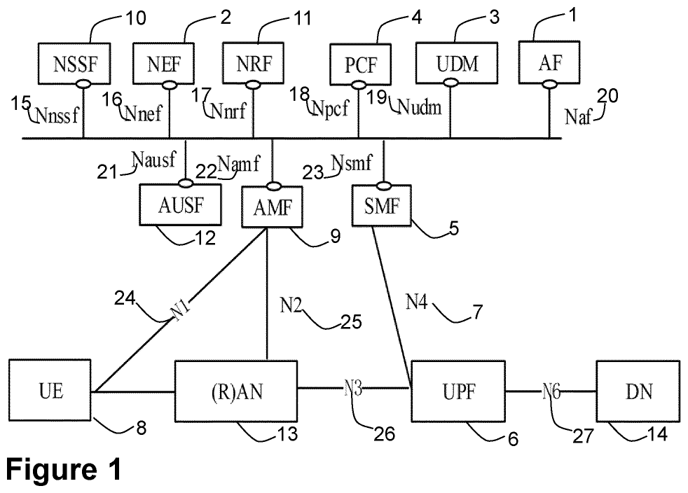

### DETAILED DESCRIPTION

Certain aspects of the present disclosure and their embodiments address one or more of the challenges identified with the existing methods and provide solutions to the challenges discussed.

Embodiments herein may relate to methods and apparatus to enforce service level agreements for exposure on outbound roamers.

Embodiments herein may be understood to allow operators to apply SLAs in an HPLMN for exposure information. As a summarized overview, embodiments herein may be based on enforcing any restrictions for exposure traffic across PLMNs at the HPLMN, particularly, at a first node in the HPLMN such as the NEF. This may be briefly summarized as follows. The first node, e.g., the NEF, may be aware per requesting node, e.g., AF, if Event Exposure when the target UE(s) is/are in a VPLMN may be enabled or not. Additionally, the first node may keep a relation of the list of PLMNs per requesting node, where the requesting node may be allowed to receive exposure information. If a given requesting node is only allowed to receive exposure information when the target UE(s) is/are in the HPLMN, it may indicate so in the request towards a second node in the HPLMN, such as the UDM. If a given requesting node is allowed to receive exposure information when the target UE(s) is/are roaming in certain VPLMNs, it may indicate so in the request towards the second node in the HPLMN, so that the second node in the HPLMN does not attempt to contact a further node such as the AMF in the VPLMN, unless the VPLMN may be allowed for the requesting AF.

When the second node in the HPLMN receives the indication of “exposure only allowed in the HPLMN”, the second node in the HPLMN may only contact the serving further node if the further node is in the HPLMN. If the AMF is in a VPLMN, the second node in the HPLMN may respond with a proper cause code, e.g., the UE is roaming, so that the requesting node may be aware that no exposure information may be provided until the UE may return to the HPLMN. When the second node in the HPLMN receives the indication of “requesting node is allowed to receive exposure information from some VPLMNs”, if the further node is in a VPLMN, it may return a cause code, e.g., “UE is in a VPLMN”, and the VPLMN of the further node. The second node may not contact the requesting node in the VPLMN yet. If the first node receives the current VPLMN of the UE, it may check the list of allowed VPLMNs for the requesting node. If the VPLMN is allowed, it may contact the second node with a new indication, e.g., “current VPLMN is allowed for exposure information”. When the second node may receive the indication of “current VPLMN is allowed”, it may contact the further node in the VPLMN to request for exposure information, e.g., event exposure.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

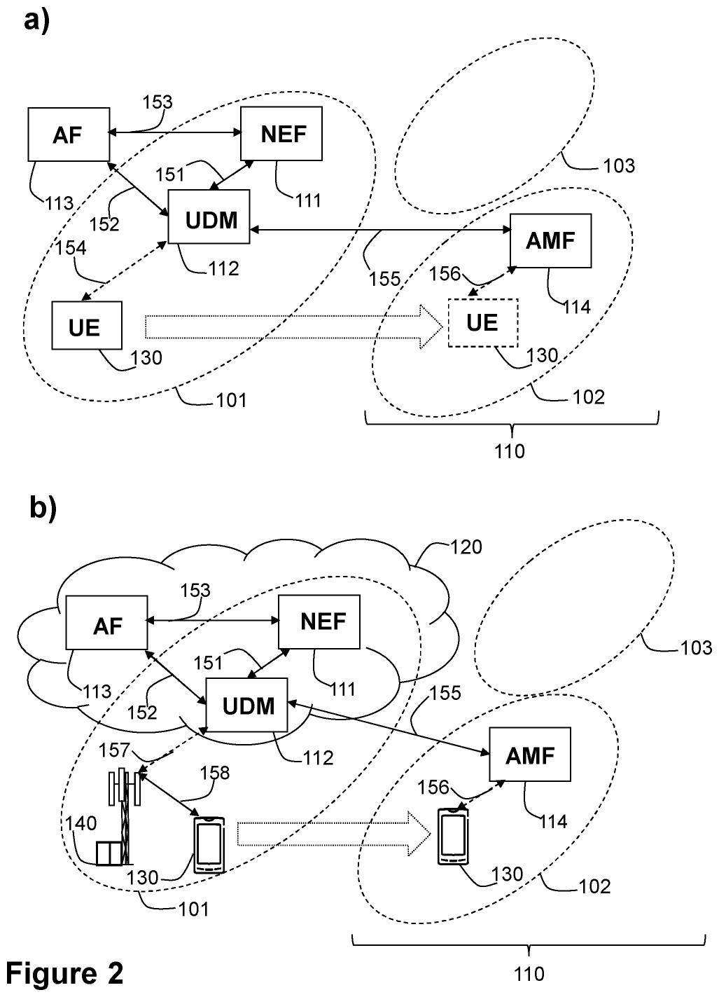

FIG. 2 depicts two non-limiting examples, in panels “a” and “b”, respectively, of a communications system 100, in which embodiments herein may be implemented. The communications system 100 may comprise a first communications network 101 and one or more roaming communications networks 110. The one or more roaming communications networks 110 may comprise a second communications network 102 and a different communications network 103 or third communications network 103. It may be understood that the one or more roaming communications networks 110 may comprise additional communications networks. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices, with serving beams.

Any of the first communications network 101 and the one or more roaming communications networks 110 may for example be a network such as a 5G system, or a newer system supporting similar functionality. The telecommunications system may also support other technologies, such as a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band, Wideband Code Division Multiple Access (WCDMA), Universal Mobile Telecommunications System Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, a third node 113 and a fourth node 114 are depicted in FIG. 2. The first node 111 and the second node 112 are comprised in the first communications network 101. The third node 113 operates in the communications system 100 via the first communications network 101. The fourth node 114 is comprised in the second communications network 102. It may be understood that the communications system 100, e.g., any of the first communications network 101 and the one or more roaming communications networks 110, may comprise more nodes than those represented on FIG. 2.

Any of the first node 111, the second node 112, the third node 113 and the fourth node 114 may be understood, respectively, as a first computer system, a second computer system, a third computer system and a fourth computer system. In some examples, any of the first node 111, the second node 112, the third node 113 and the fourth node 114 may be implemented as a standalone server in e.g., a host computer in the cloud 120, as depicted in the non-limiting example depicted in panel b) of FIG. 2. Any of the first node 111, the second node 112, the third node 113 and the fourth node 114 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113 and the fourth node 114 may also be implemented as processing resources in a server farm.

Any of the first node 111, the second node 112, the third node 113 and the fourth node 114 may be independent and separate nodes. In some examples, the first node 111 and the second node 112 may be co-localized.

In some examples of embodiments herein, the first node 111 may be understood as a node that may have a capability to manage exposure to different events, e.g., different Exposure Application Program Interfaces (APIs). The first node 111 may optionally support other functionalities, such as handling e.g., sponsored Data, Quality of Service (QOS), etc., which may allow a content provider to request policies from the Mobile Network Operator (MNO). In the non-limiting example of FIG. 2, the first node 111 is a NEF.

The second node 112 may be a node that may have a capability to handle user identification, support a UE's Serving NF Registration Management, e.g., storing the serving Access and Mobility Function (AMF) for a UE, storing the serving Session Management Function (SMF) for a UE's Packet Data Unit (PDU) Session, etc., support retrieval of the UE's individual subscription data for access and mobility and session management, and handle subscription for network exposure capabilities applicable to an individual UE or a group of UE. As depicted in the non-limiting example of FIG. 2, a non-limiting example of the second node 112, wherein the communications system 100 may be a 5G network, may be UDM.

The third node 113 may be a node having a capability to manage service of an application to a wireless device. In some particular examples, the third node 113 may be an AF, e.g., in a 5G network.

The fourth node 114 may be a node having a capability to manage access of a device such as the device 130 described below, for example, when the device 130 may be connected through different access networks, and mobility aspects of the device 130. In some particular examples, the fourth node 114 may be an AMF, e.g., in a 5G network.

The communications system 100 may comprise a plurality of devices, of which a device 130 is represented in FIG. 2. The device 130 may be also known as e.g., user equipment (UE), a wireless device, mobile terminal, wireless terminal and/or mobile station, mobile telephone, cellular telephone, or laptop with wireless capability, an Internet of Things (IoT) device, a sensor, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The first communications network 101 may be understood to be a home network, e.g., a HPLN to the device 130. The one or more roaming communications networks 110 may be understood to be one or more visiting networks, e.g., VPLNs to the device 130. In FIG. 2, the thick dashed arrow indicates that the device 130 may roam from its home network, the first communications network 101, to, for example, the second communications network 102. The device 130 roaming in the second communications network 102 is indicated by the dashed lines.

The communications system 100 may comprise a plurality of radio network nodes, whereof a radio network node 140 is depicted in FIG. 2b as being comprised in the first communications network 101. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

Any of the first communications network 101 and the one or more roaming communications networks 110 may cover a geographical area which may be divided into cell areas, wherein each cell area may be served by a radio network node, although, one radio network node may serve one or several cells.

The first node 111 may communicate with the second node 112 over a first link 151, e.g., a radio link or a wired link. The second node 112 may communicate with the third node 113 over a second link 152, e.g., a radio link or a wired link. The first node 111 may communicate with the third node 113 over a third link 153, e.g., a radio link or a wired link. The second node 112 may communicate, directly or indirectly, with the device 130 over a fourth link 154, e.g., a radio link or a wired link. The second node 112 may communicate, directly or indirectly, with the fourth node 114 over a fifth link 155, e.g., a radio link or a wired link. The fourth node 114 may communicate, directly or indirectly, with the device 130, when roaming in the second communications network 102, over a sixth link 156, e.g., a radio link or a wired link. The second node 112 may communicate, directly or indirectly, with the radio network node 140 over a seventh link 157, e.g., a radio link or a wired link. The radio network node 140 may communicate with the device 130 over an eighth link 158, e.g., a radio link. Nodes comprised in the first communications network 101 may communicate with one or more nodes comprised in the second communications network 102 over one or more links, which are not depicted in FIG. 2 to simplify the Figure. Similarly, the device 130 may communication with the one or more nodes comprised in the second communications network 102 over one or more other links, which are not depicted either in FIG. 2 to simplify the Figure.

Any of the respective first link 151, the second link 152, the third link 153, the fourth link 154, the fifth link 155, the sixth link 156, the seventh link 157 and/or the eighth link 158 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

In general, the usage of “first”, “second”, “third”, “fourth”, “fifth”, “sixth”, “seventh” and/or “eighth” herein may be understood to be an arbitrary way to denote different elements or entities and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

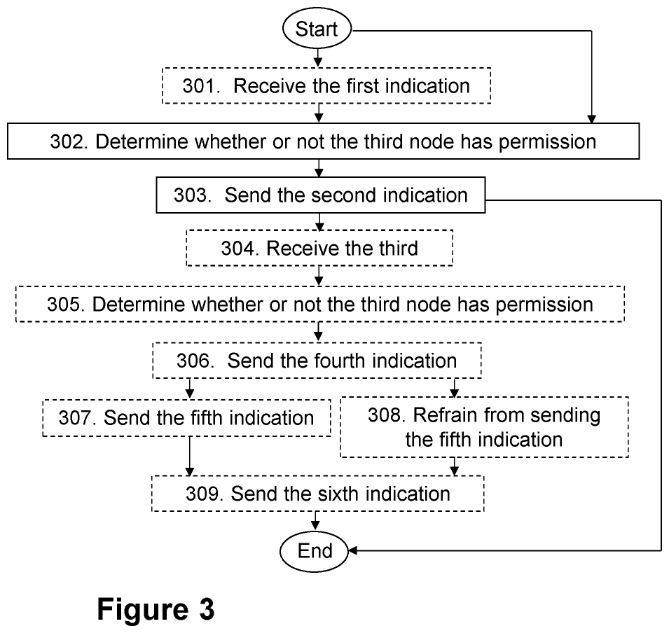

Embodiments of a computer-implemented method, performed by the first node 111, will now be described with reference to the flowchart depicted in FIG. 3. The method may be understood to be for handling exposure to an event for the device 130. The first node 111 operates in the first communications network 101. The first communications network 101 is a home network to the device 130 and to the second node 112.

Several embodiments are comprised herein. The method may comprise one or more of the following actions. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 3.

In FIG. 3, optional actions are represented with dashed lines.

### Action 301

In this Action 301, the first node 111 may receive a first indication from the third node 113. The first indication indicates a request to receive a notification of the event for the device 130. In other words, in this Action 301, the third node 113 may subscribe to a given event, e.g., UE location change for a given device, the device 130.

The receiving of the first indication may be performed e.g., via the third link 153.

The first indication may further indicate, a type of the event, e.g., Event type, an identity of the device 130, e.g., UE ID, an identity of the third node 113, e.g., AF ID, and an identity of a provider of the third node 113, e.g., an MTC provider ID.

In some embodiments, the first node 111 may be a NEF and the third node 113 may be an AF. In some of such embodiments, the first indication may be a Nnef_EventExposure_Subscribe.

In some embodiments, the first node 111 may be a NEF, the third node 113 may be an AF, and the second node 112 may be a UDM.

### Action 302

According to embodiments herein, the first node 111 may be aware per third node 113 if Event Exposure when the target UE(s) may be in a roaming communications network, e.g., VPLMN, may be enabled or not. Additionally, the first node 111 may keep a relation of a list of communications networks per third node 113, where the third node 113 may be allowed to receive exposure information.

In this Action 302, the first node 111 determines whether or not the third node 113 operating in the communications system 100 via the first communications network 101 has permission to receive notifications of the event while the device 130 is roaming in the second communications network 102. The determining in this Action 302 is performed in response to the first indication received from the third node 113 indicating the request to receive the notification of the event for the device 130. The determining in this Action 302 is based on one or more agreements of the third node 113 with the first communications network 101 to service the device 130 in the one or more roaming communications networks 110.

Determining in this Action 302 may be understood as e.g., checking.

That the determining in this Action 302 is performed in response to the first indication may be understood to mean that when the first node 111 may receive the request from the third node 113, it may check whether the third node 113 may be allowed to receive exposure information from the one or more roaming communications networks 110.

In some embodiments, the one or more agreements to receive service may be one or more SLAs. Therefore, in this Action 302, the first node 111 may, based on local configuration, check the SLAs for the requesting third node 113. The third node 113 may be allowed to receive exposure information: 1) only from the first communications network 101, that is, the HPLMN; 2) for the HPLMN and some, that is, few, of the one or more roaming communications networks 110, that is, the VPLMNs; and 3) from the first communications network 101 and all of the one or more roaming communications networks 110, except some, or a few, communications networks, that is, PLMNs. In the latter cases, the first node 111 may have a list of communications networks comprised in the one or more roaming communications networks 110, e.g., VPLMNs, blacklisted and/or whitelisted per third node 113. The configuration of the list of the one or more roaming communications networks 110 from which reporting of event exposure information may be allowed may be aligned with the list of communications networks the first communications network 101 may have roaming agreements with. This may be understood to be, for the sake of a clean configuration. It may be beneficial that the list of one or more roaming communications networks 110 where reporting of exposure events may be allowed for a given third node 113 may not include a communications network for which the first communications network 101 may not have agreements with.

In some embodiments, the determining in this Action 302 of whether or not the third node 113 may have permission to receive notification indicating the exposure to the event while the device 130 is roaming in the second communications network 102 may be performed per at least one of: application function, type of event, identifier of the device 130 and service provider.

By determining whether or not the third node 113 has permission to receive the notifications of the event based on the one or more agreements in this Action 302, the first node 111 may then be enabled to act accordingly within the first communications network 101 and avoid that requests to receive the notifications may be sent over to a communications network where the third node 113 may not have permission to receive them anyway. That is, exposure information may be enabled to be disallowed at the home network instead of at the visiting network, thereby avoiding unnecessary signalling overhead.

### Action 303

In this Action 303, the first node 111 sends a second indication to the second node 112 operating in the first communications network 101. The second indication indicates a result of the determination. The second indication may be a subscription request.

In embodiments wherein the first node 111 may be a NEF and the second node 112 may be a UDM, the second indication may be a Nnef_EventExposure_Subscribe. Particularly, the second indication may be a Nnef_EventExposure_Subscribe which may indicate e.g., “roaming_exposure_not_allowed”. The second indication may further indicate the event type and the identity of the device 130.

If the third node 113 may only be allowed to receive exposure information from the first communications network 101, that is, when the target device 130 may be in the first communications network 101, the first node 111 may include a new indication, the second indication, towards the second node 112, to indicate so in the request towards the second node 112, so that the second node 112 may know not to subscribe to the fourth node 114, e.g., an AMF, if the another network node may be in one or the one or more roaming communications networks 110, that is, in a VPLMN. For example, in a first group of embodiments, with the proviso the first node 111 may determine the third node 113 may lack permission for roaming exposure, the second indication may explicitly indicate the third node 113 lacks permission for roaming exposure. In such embodiments, the second indication may indicate, for example that “exposure only allowed in the HPLMN”. The second node 112 may then be aware to only contact the serving fourth node 114 if the fourth node 114 is in the first communications network 101. If the fourth node 114 is in a roaming communications network, the second node 112 may respond with a proper cause code, e.g., the device 130 is roaming, so that the third node 113 may be aware that no exposure info may be provided until the device 130 may return to the first communications network 101.

The sending of the second indication in this Action 303 may be performed e.g., via the first link 151.

If the third node 113 is allowed to receive exposure information when the device 130 may be roaming in certain roaming communications network, it may indicate so in the request towards the second node 112 so that the second node 112 may not attempt to contact the third node 113 in the second communications network 102 unless the second communications network 102 may be allowed for the requesting third node 113.

In a second group of embodiments, the third node 113 may have permission to receive the notification indicating the exposure to the event while roaming in a first subset of the one or more roaming communications networks 110. That is, the third node 113 may be is allowed to receive exposure information from the one or more roaming communications networks 110 may be allowed. The first subset may have a number of networks lower than a first threshold. That is, in the second group of embodiments, the third node 113 may be allowed in some, that is, a few of the one or more roaming communications networks 110.

In the second group of embodiments, with the proviso the third node 113 may have permission to receive the notification indicating the exposure to the event while roaming in the first subset of the one or more roaming communications networks 110, the first subset having the number of networks lower than the first threshold, the second indication may indicate at least one of the following two options. According to the first option, the second indication may indicate the third node 113 has permission to receive the notification indicating the exposure to the event while roaming in at least one of: i) the first subset, as explicitly indicated, ii) the first subset, as pre-configured at the second node 112, and iii) any communications network where the device 130 is allowed to register for roaming. For options i) and ii), the first subset may be explicitly indicated or pre-configured as a blacklist and/or whitelist of roaming communications networks of the one or more roaming communications networks 110, that is, VPLMs, if the subset is fairly small, to inform the second node 112 that the third node 113 may be allowed to receive exposure information only from those roaming communications networks in the whitelist or that the third node 113 may not be allowed to receive exposure information from those roaming communications networks in the blacklist. In particular, for option ii), the second indication may indicate e.g., “default/pre-defined list of VPLMNs allowed for exposure shall be used”. This may be understood to mean that a list locally pre-configured in the second node 112 for exposure agreements may be used for the request. This new list configured may be understood to be a subset of an existing local list of VPLMNs which may be configured in the second node 112 for roaming agreements. For option iii), any communications network where the device 130 is allowed to register for roaming may be indicated, for example with the second indication as “all VPLMNs allowed for roaming are also allowed for exposure”. This may be understood to mean that if the device 130 is registered in any roaming communications network, exposure may be allowed for the request, e.g., for the subscribed event.

According a second option, the second indication may indicate, a first request for the second node 112 to perform re-authorization of whether or not the third node 113 has permission to receive the notification with the proviso the device 130 roams into a different communications network 103. The first request for the second node 112 to perform re-authorization may be sent as an indicator of an endpoint in the first node 111 the second node 112 may have to use to perform re-authorization with the first node 111, of whether or not the third node 113 may have permission to receive the notification of the event while the device 130 may be roaming in the second communications network 102. The indicator may be a Uniform Resource Indicator (URI) of the first node 111. The first request may therefore be a new re-authorization URI of the first node 111, so that the second node 112 may use it to re-authorize exposure roaming agreements. That is, the second node 112 may have to check whether exposure information may be allowed from the current roaming communications network and at every change of identifier of the roaming network, e.g., PLMN-ID.

If both, the first request, e.g., the reauthorization indicator, e.g., URI, of the first node 111, and the first subset, e.g., the blacklist and/or whitelist of roaming communications networks are sent to the second node 112, it may be up to the second node 112 whether to store, e.g., in UDR, either the indicator, e.g., URI, or the first subset, e.g., VPLMN list. If the indicator is stored, the second node 112 may have to re-authorize via the first node 111 at every identifier of the roaming network, e.g., VPLMN-ID, where the device 130 may register. If the second node 112 stores the first subset, e.g., list of VPLMNs, allowed for exposure for this request, the second node 112 may never re-authorize via the first node 111. Instead, the re-authorization may be solely performed by the second node 112.

In a third group of embodiments, the third node 113 may have permission to receive the notification indicating the exposure to the event while roaming in a second subset of the one or more roaming communications networks 110, wherein the second subset may have the number of networks exceeding a second threshold. That is, the third node 113 may be allowed in many roaming communications networks, e.g., VPLMNs.

In the third group of embodiments, with the proviso the third node 113 may have permission to receive the notification indicating the exposure to the event while roaming in the second subset of the one or more roaming communications networks 110, wherein the second subset may have the number of networks exceeding the second threshold, the second indication may indicate the indicator of the endpoint in the first node 111 the second node 112 may have to use to perform re-authorization with the first node 111. The re-authorization may be of whether or not the third node 113 may have permission to receive the notification of the event while the device 130 is roaming in the second communications network 102. The second communications network 102 may be comprised in the second subset. The re-authorization may have to be performed with the proviso the device 130 may roam into a different communications network 103.

In some of the embodiments from the third group of embodiments, the second indication may further indicate the first request for the second node 112 to perform the re-authorization.

That is, when the first node 111 may receive the request for the second node 112, it may check whether the third node 113 may be allowed to receive exposure information from the one or more roaming communications networks 110. If the second subset, e.g., blacklist and/or whitelist of roaming communications networks is large, the first node 111 may include a new indication towards the second node 112, e.g., indicating “roaming authorization required”, to instruct the second node 112 that, if the device 130 is located in a roaming communications network, the second node 112 may be required to not subscribe to the fourth node 114 and instead inform first node 111 in the response, e.g., the device 130 is in a roaming communications network, together with the identifier of the roaming network, e.g., VPLMN-ID, so that the first node 111 may be able to perform authorization checks for the requesting third node 113, and the current roaming communications network where the device 130 may be camping.

By sending the second indication to the second node 112 in this Action 303, the first node 111 may enable that the second node 112 may only contact the serving fourth node 114 if the device 130 is in a communications network wherein, according to the one or more agreements, it may have permission to receive notifications of the event while roaming, or if the device 130 may be located in the first communications network 101. Since the exposure information may be disallowed in the home network, and not in the visiting network, signalling overhead may be allowed to be saved and latency may be allowed to be reduced in the service to the device 130, enabling to improve the performance of the communications system 100.

### Action 304

After storing the event subscription, e.g., in UDR, including the indicator, e.g., URI, of the first node 111 for authorization of the identifier of the roaming network, e.g., VPLMN-ID, the second node 112 may check the current communications network the device 130 may be connected from. If the device 130 is in a roaming communications network, the second node 112 may not subscribe to the fourth node 114 and respond to the first node 111 in this Action 304.

In this Action 304, the first node 111 may receive a third indication from the second node 112. The third indication may indicate whether or not the device 130 may be roaming. The third indication may be based on the sent second indication. The third indication may be a cause, such as for example “UE in VPLMN”, and the current identifier of the roaming network, e.g., VPLMN-ID.

In embodiments wherein the first node 111 may be a NEF and the second node 112 may be a UDM, the third indication may be a Nudm_EventExposure_Subscribe_Response. Particularly, the third indication may be a Nudm_EventExposure_Subscribe_Response which may indicate e.g., “ue_roamer_not_allowed” or “vplmn not allowed”. The third indication may further indicate a successful response to the subscription request, e.g, “OK”.

The receiving of the second indication in this Action 304 may be performed e.g., via the third link 153.

In some embodiments, the third indication may indicate one of the following. In a first option, the third indication may indicate the device 130 is roaming in the second communications network 102 and a first identifier of the second communications network 102. In a second option, the third indication may indicate the received request to receive the notification of the event for the device 130 has been successful.

The first identifier may be, e.g., an VPLMN-ID.

By receiving the third indication in this Action 303, the first node 111 may be enabled to determine whether or not the third node 113 may have permission to receive the notification about the event, e.g., in instances wherein the third node 113 may be allowed to receive the notification in many roaming communications networks, and then notify the third node 113 accordingly, e.g., indicating whether or not the device 130 may be roaming, and whether or not the third node 113 may have permission to receive the notification. This may in turn enable the third node 113 to decide whether or not to 1) keep the subscription to the event and wait for the device 130 to return to the first communications network 101 to receive the event reporting, 2) end the subscription and subscribe to roaming status change to reattempt the subscription when the device 130 may return to the first communications network 101, so that the event subscription may be reattempted or 3) end the subscription and reattempt later.

### Action 305

In this Action 305, the first node 111 may determine whether or not the third node 113 may have permission to receive the notification indicating the exposure to the event while the device 130 may be roaming in the second communications network 102. The determining in this Action 305 may be performed in response to the third indication that may have been received from the second node 112. The determining in this Action 305 may be based on the one or more agreements.

This Action 305 may be performed in embodiments wherein the third indication may indicate the device 130 may be roaming in the second communications network 102 and the first identifier of the second communications network 102. That is, the first node 111 may check the returned first identifier, e.g., VPLMN-ID, against the allowed roaming communications networks, e.g., VPLMNs, for the requesting third node 113.

By determining whether or not the third node 113 may have permission to receive the notification indicating the exposure to the event while the device 130 may be roaming in the second communications network 102 in this Action 305, the first node 111 may be enabled to notify the third node 113 accordingly. As stated earlier, this may in turn enable the third node 113 to take action accordingly, that is, decide whether or not to 1) keep the subscription to the event and wait for the device 130 to return to the first communications network 101 to receive the event reporting, 2) end the subscription and subscribe to roaming status change to reattempt the subscription when the device 130 may return to the first communications network 101, so that the event subscription may be reattempted or 3) end the subscription and reattempt later.

### Action 306

In this Action 306, the first node 111 may send a fourth indication to the third node 113. The fourth indication may be based on the received third indication. The fourth indication may indicate whether or not the device 130 may be roaming, and whether or not the third node 113 may have permission to receive the notification.

In embodiments wherein the first node 111 may be a NEF and the third node 113 may be an AF, the fourth indication may be a Nudm_EventExposure_Subscribe_Response. Particularly, the fourth indication may be a Nudm_EventExposure_Subscribe_Response which may indicate e.g., “ue_roamer_not_allowed” or “vplmn not allowed”. The fourth indication may further indicate a successful response to the subscription request, e.g., “OK”.

In some embodiments, with the proviso the first node 111 may determine the third node 113 lacks permission for roaming exposure, the second indication may explicitly indicate the third node 113 lacks permission for roaming exposure, the third indication may indicate the device 130 is roaming and the third node 113 may lack permission to receive the notification while the device 130 is roaming, the fourth indication may indicate the device 130 is roaming and the third node 113 lacks permission to receive the notification. For example, if the device 130 is located in a non-allowed roaming communications network, e.g., VPLMN, not whitelisted or blacklisted, the first node 111 may respond to the third node 113 successfully but may include the fourth indication as a cause code indicating that the device 130 may be currently in a non-allowed roaming communications network, e.g., VPLMN. This may indicate that the event reporting may not be going to be performed until the device 130 may return to the first communications network 101 or moves to an allowed roaming communications networks.

If the third node 113 may have permission to receive the notification indicating the exposure to the event while roaming in the first subset of the one or more roaming communications networks 110, that is, if the second communications network 102 is allowed, the first node 111 may immediately update the subscription with the fourth indication towards the second node 112 indicating, e.g., “current VPLMN allowed”, to instruct the second node 112 to subscribe to the fourth node 114 given that the second node 112 may have now confirmation that the request may proceed. The first node 111 may also respond successfully to the third node 113 since the event reporting may be expected from the second communications network 102, that is, the current VPLMN. In other words, the event(s) may be allowed to be reported by the fourth node 114 in the second communications network 102.

As stated earlier, in the second group of embodiments, with the proviso the third node 113 may have permission to receive the notification indicating the exposure to the event while roaming in the first subset of the one or more roaming communications networks 110. The first subset may have the number of networks lower than the first threshold, the second indication may indicate at least one of: a) the third node 113 has permission to receive the notification indicating the exposure to the event while roaming in at least one of: i) the first subset, as explicitly indicated, ii) the first subset, as pre-configured at the second node 112, and iii) any communications network where the device 130 is allowed to register for roaming, and b) the first request for the second node 112 to perform re-authorization of whether or not the third node 113 has permission to receive the notification with the proviso the device 130 roams into the different communications network 103. In some of these embodiments, the third indication and the fourth indication may indicate at least one of: i) the received request to receive the notification about the exposure of the event for the device 130 has been successful, ii) the device 130 is roaming in the second communications network 102, and iii) the device 130 is roaming and lacks permission to receive the notification in the second communications network 102.

As stated earlier, in the third group of embodiments, with the proviso the third node 113 may have permission to receive the notification indicating the exposure to the event while roaming in the second subset of the one or more roaming communications networks 110. The second subset may have the number of networks exceeding the second threshold, the second indication may indicate the indicator of the endpoint in the first node 111 the second node 112 may have to use to perform re-authorization with the first node 111. The re-authorization may be of whether or not the third node 113 may have permission to receive the notification of the event while the device 130 is roaming in the second communications network 102. The second communications network 102 may be comprised in the second subset. The re-authorization may have to be performed with the proviso the device 130 may roam into the different communications network 103.

When the third node 113 may receive the fourth indication that the device 130 may be roaming, e.g., as the “UE is registered in a VPLMN”, it may be up to the third node 113 whether to 1) keep the subscription to the event and wait for the device 130 to return to first the communications network 101 to receive the event reporting, 2) end the subscription and subscribe to roaming status change to reattempt the subscription when the device 130 may return to the communications network 101 so that the event subscription may be reattempted or 3) end the subscription and reattempt later.

The sending of the fourth indication in this Action 306 may be performed e.g., via the third link 153.

By sending the fourth indication to the third node 113 in this Action 306, the first node 111 may be enabled to achieve the benefits outlined earlier, in relation to Action 305.

### Action 307

In this Action 307, the first node 111 may send a fifth indication to the second node 112. The fifth indication may indicate the result of the determination performed based on the received third indication.

The sending of the fifth indication in this Action 307 may be performed e.g., via the first link 151.

This Action 305 may be performed in embodiments wherein the third indication may indicate the device 130 may be roaming in the second communications network 102 and the first identifier of the second communications network 102.

If the reporting of exposure information from the received roaming communications network, e.g., VPLMN, is allowed, the first node 111 may respond with the fifth indication indicating, e.g., “VPLMN authorized”, so that the second node 112 may subscribe to the fourth node 114, since the event(s) may be allowed to be reported by the fourth node 114 in the second communications network 102, e.g., VPLMN.

If the reporting of exposure information from the received roaming communications network, e.g., VPLMN is not allowed, the first node 111 may respond with the fifth indication indicating, e.g., “VPLMN not authorized”, so that the second node 112 may remove the event(s) at the new fourth node 114, if required. The second node 112 may not subscribe towards the fourth node 114 in any case. The first node 111 may include a new cause code in a notification towards the third node 113 indicating that the device 130 may be currently in a non-allowed roaming communications network, e.g., VPLMN. That is, event reporting may be not going to be performed until the device 130 may return to the first communications network 101 or move to an allowed roaming communications network.

By sending the fifth indication to the second node 112 in this Action 307, the first node 111 may enable the second node 112 to then only contact the serving fourth node 114 if the device 130 is in a communications network wherein, according to the one or more agreements, it may have permission to receive notifications of the event while roaming, or if the wireless device 130 may be located in the first communications network 101. This may allow to save signalling overhead and reduce latency in the service to the device 130, enabling to improve the performance of the communications system 100. If the fourth node 114 is in a roaming communications network wherein, according to the one or more agreements, the third node 113 may not have permission to receive notifications, the first node 111 may enable to save further signalling overhead by performing the next Action 308.

### Action 308

In this Action 308, the first node 111 may refrain from sending the fifth indication to the second node 112, with a proviso the first node 111 may determine the third node 113 lacks permission to receive the notification.

This Action 305 may be performed in embodiments wherein the third indication may indicate the device 130 may be roaming in the second communications network 102 and the first identifier of the second communications network 102.

By refraining from sending the fifth indication in this Action 308, the first node 111 may enable the second node 112 to then only contact the serving fourth node 114 if the device 130 is a communications network wherein, according to the one or more agreements, it may have permission to receive notifications of the event while roaming, or if the wireless device 130 may be located in the first communications network 101. In other words, the exposure information may be disallowed in the home network, as opposed to performing it in the visiting network. This may be understood to allow to save signalling overhead and reduce latency in the service to the device 130, enabling to improve the performance of the communications system 100.

### Action 309

In this Action 309, the first node 111 may send a sixth indication to the third node 113. The sixth indication may indicate a result of the determination performed based on the received third indication.

This Action 305 may be performed in embodiments wherein the third indication may indicate the device 130 may be roaming in the second communications network 102 and the first identifier of the second communications network 102. In some of these embodiments, the method may further comprise performing Action 305, Action 309 and one of Action 307 and Action 308, as described above.

The sending of the sixth indication in this Action 309 may be performed e.g., via the third link 153.

By sending the sixth notification to the third node 113 in this Action 309, the first node 111 may enable the third node 113, e.g., in instances wherein the third node 113 may be allowed to receive the notification in many roaming communications networks, to decide whether or not to 1) keep the subscription to the event and wait for the device 130 to return to the first communications network 101 to receive the event reporting, 2) end the subscription and subscribe to roaming status change to reattempt the subscription when the device 130 may return to the first communications network 101, so that the event subscription may be reattempted or 3) end the subscription and reattempt later.

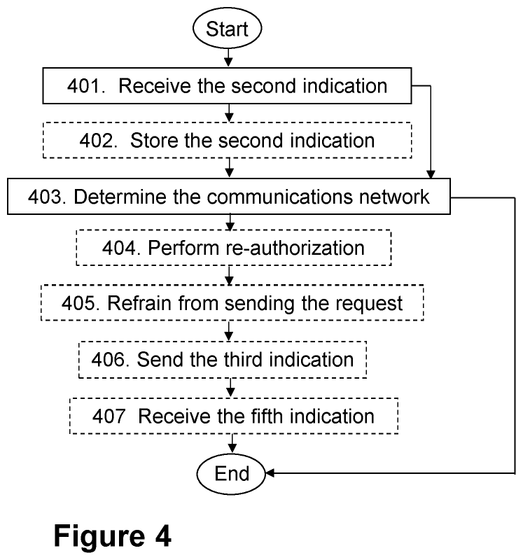

Embodiments of a computer-implemented method performed by the second node 112, will now be described with reference to the flowchart depicted in FIG. 4. The method may be understood to be for handling the exposure to the event for the device 130. The second node 112 operates in the first communications network 101. As stated earlier, the first communications network 101 is a home network to the device 130.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are depicted with dashed lines.

The detailed description of some of the following corresponds to the same references provided above, in relation to the actions described for the first node 111 and will thus not be repeated here to simplify the description. For example, in some embodiments, the first node 111 may be a NEF, the third node 113 may be an AF, and the second node 112 may be a UDM.

### Action 401

In this Action 401, the second node 112 receives the second indication from the first node 111 operating in the first communications network 101. The second indication indicates whether or not the third node 113 operating in the communications system 100 via the first communications network 101 has permission to receive notifications of the event while the device 130 is roaming in the second communications network 102. The second indication is based on the one or more agreements of the third node 113 with the first communications network 101 to service the device 130 in the one or more roaming communications networks 110.

The one or more agreements to receive service may be the one or more SLAs.

The receiving in this Action 401 may be performed e.g., via the first link 151.

In the first group of embodiments, with the proviso the third node 113 may lack permission for roaming exposure, the second indication may explicitly indicate the third node 113 may lack permission for roaming exposure.

In some embodiments, the second indication may further indicate the first request for the second node 112 to perform the re-authorization.

In the second group of embodiments, with the proviso the third node 113 may have permission to receive the notification indicating the exposure to the event while roaming in the first subset of the one or more roaming communications networks 110, the first subset having the number of networks lower than the first threshold, the second indication may indicate at least one of the following. According to a first option a), the third node 113 may have permission to receive the notification indicating the exposure to the event while roaming in at least one of: i) the first subset, as explicitly indicated, ii) the first subset, as pre-configured at the second node 112, and iii) any communications network where the device 130 may be allowed to register for roaming. According to a second option, b) the first request for the second node 112 to perform re-authorization of whether or not the third node 113 may have permission to receive the notification with the proviso the device 130 may roam into a different communications network 103.

In the third group of embodiments, with the proviso the third node 113 may have permission to receive the notification indicating the exposure to the event while roaming in the second subset of the one or more roaming communications networks 110, the second subset having the number of networks exceeding the second threshold, the second indication may indicate the indicator of the endpoint in the first node 111 the second node 112 may have to use to perform re-authorization with the first node 111, e.g., the URI. The re-authorization may be understood to be of whether or not the third node 113 may have permission to receive the notification. That is, the notification indicating the exposure to the event while the device 130 may be roaming in the second communications network 102. The second communications network 102 may be comprised in the second subset. The re-authorization may have to be performed with the proviso the device 130 may roam into a different communications network 103.

### Action 402

In this Action 402, the second node 112 may store the second indication. For example, in embodiments wherein the second node 112 may be the UDM, the storing in this Action 402 may be in another node, which may be referred to herein as a fifth node, e.g., a UDR.

The second node 112 may then perform one or more actions based on the additional information included by the first node 111 in the second indication, e.g., which may be a subscription request.

In some embodiments, with the proviso the second indication may comprise the first request to perform re-authorization, the storing in this Action 402 may comprise storing at least one of: the first request and the first subset.

If the request from the first node 111 included a new indication “all VPLMNs allowed for roaming are also allowed for exposure”, then the second node 112 may interpret that the first communications network 101 may enable, for the requesting third node 113, reporting of exposure information from all the roaming communications networks 110 the first communications network 101 may have roaming agreements with, which may be locally configured in the second node 112. That is, all roaming communications networks where the device 130 may be allowed to be registered by the second node 112, may also be allowed for exposure. In this case, the second node 112 may store a new indication, e.g., in the UDR, for this request, such as, for example, “list of allowed VPLMNs and list of allowed VPLMNs for exposure is the same”. This may be understood to mean that the second node 112 may never initiate reauthorization towards the first node 111, as it may be understood that it may not need to.

### Action 403

In this Action 403, the second node 112 may determine which communications network the device 130 may be registered with.

In some embodiments of the second group of embodiments, one of the following four options may apply. In a first option, with the proviso the second indication may lack the first request to perform re-authorization, the second node 112 may store the second indication and the determining in this Action 403 may further comprise determining whether the communications network the device 130 is registered with may be allowed for exposure.

If the request from the first node 111 included the blacklist/whitelist of the one or more roaming communications networks 110, e.g., VPLMNs, the second node 112 may check in this Action 403 the received VPLMN list and decide whether to send the subscription request to the fourth node 114 depending on whether the VPLMN where the device 130 may be registered from may be allowed or not.

The determining in this Action 403 of whether or not the third node 113 may have permission to receive notification indicating the exposure to the event while the device 130 may be roaming in the second communications network 102, may be performed per at least one of: application function, type of event, identifier of the device 130 and service provider.

### Action 404

In a second option, with the proviso the second indication may comprise the first request to perform re-authorization, the storing in Action 402 may comprise storing at least one of: the first request and the first subset, and in this Action 404, the second node 112 may optionally, perform re-authorization with the first node 111 of whether or not the third node 113 may have permission to receive the notification with the proviso the device 130 may roam into a different communications network 103.

If, in addition to the blacklist/whitelist, the first node 111 also included the indicator of the endpoint in the first node 111 the second node 112 may have to use to perform re-authorization with the first node 111, that is, the URI to be used by the second node 112 to re-authorize exposure roaming agreements via the first node 111, the second node 112 may either store, in Action 402, this URI, e.g., in the UDR, or may store the blacklist/whitelist of VPLMs. This way, depending on what may have been stored in the UDR, the second node 112 may use either the indicator, e.g., URI to request the first node 111 to reauthorize whether each new roaming communications network 110, e.g., VPLMN-ID, where the device 130 may register may be allowed for exposure, or the second node 112 may use the stored list in the UDR and never initiate re-authorization towards the first node 111 at change of roaming communications network 110, e.g., VPLMN-ID change.

In a third option, with the proviso the third indication may indicate the third node 113 may have permission to receive the notification while roaming in the first subset, as pre-configured at the second node 112 or in any communications network where the device 130 may be allowed to register for roaming, the second node 112 may refrain from performing the re-authorization.

If the request from the first node 111 included a new indication, e.g., “default list of VPLMNs allowed for exposure shall be used”, then the second node 112 may interpret that the first communications network 101 may enable that, for the requesting third node 113, reporting of exposure information may be allowed for all the roaming communications networks 110 locally configured in the second node 112 for exposure roaming agreements. This new local list configured in the second node 112 may be a subset of existing local list of VPLMNs which may be configured in the second node 112 for roaming agreements. In this case, when compared to existing methods, the second node 112 may store, in Action 403, an additional new indication of “default list of VPLMNs allowed for exposure” in the UDR for this request. In this case, the second node 112 may use the new locally configured list of roaming communications networks 110 for exposure roaming agreements. This may be understood to mean that the second node 112 may never initiate reauthorization towards the first node 111.

If the first node 111 included the blacklist/whitelist but did not include the indicator of the endpoint in the first node 111 the second node 112 may have to use to perform re-authorization with the first node 111, e.g., the URI, to avoid the second node 112 contacting the first node 111 to re-authorize at change of roaming communications network, e.g., VPLMN-ID change, then the second node 112 may, in Action 402, store, e.g., in the UDR, the received blacklist/whitelist of VPLMs together, so that second node 112 may check whether each new VPLMN where the device 130 may register may be allowed for exposure. This may be understood to mean that second node 112 may never initiate reauthorization towards the first node 111, that is, that the second node 112 may refrain from performing reauthorization towards the first node 111.

In a fourth option, with the proviso the second indication may only comprise the first request to perform re-authorization, the storing in this Action 402 may comprise storing the first request and second node 112 may perform the re-authorization.

If the request from the first node 111 included only the indicator of the endpoint in the first node 111 the second node 112 may have to use to perform re-authorization with the first node 111, that is, the URI in the first node 111 in which the second node 112 may need to authorize exposure roaming agreements, the second node 112 may store the indicator in the UDR in Action 402. This may be understood to mean that the second node 112 may initiate reauthorization towards the first node 111 every time the device 130 may register in a different roaming communications network, e.g., VPLMN-ID.

The information to be included by the first node 111 may be determined via local configuration e.g., on a per AF basis.

If the second node 112 detects a new reauthorization indicator, e.g., a new URI address of the first node 111 associated to stored event(s) at registration of the device 130, the second node 112 may check whether there may be a change of PLMN-ID in Action 403 and if so, the second node 112 may send an authorization request to each URI address. The second node 112 may include the new VPLMN-ID in the authorization request.

### Action 405

In some embodiments, with the proviso the second node 112 may determine the device 130 is roaming, from the first communications network 101, in the second communications network 102, the second node 112 may, in this Action 405, refrain from sending a request to receive the notification indicating the exposure to the event to the fourth node 114 in the second communications network 102.

If the fourth node 114 currently serving the device 130 is located in the first communications network 101, that is, the HPLMN, then the second node 112 may send the subscription request to the fourth node 114.

### Action 406

In this Action 406, the second node 112 sends the third indication to the first node 111. The third indication indicates whether or not the device 130 is roaming. The third indication is based on the sent second indication.

If the device 130 is located in the first communications network 101, or an allowed roaming communications network, that is, VPLMN, e.g., whitelisted or not blacklisted, the second node 112 may send the subscription towards the fourth node 114 and respond successfully to the first node 111 in this Action 406, as in the baseline.

In some embodiments, the third indication may indicate one of: i) the device 130 is roaming in the second communications network 102, and ii) the received request to receive the notification about the exposure of the event for the device 130 has been successful. For example, if the fourth node 114, e.g., AMF, currently serving the device 130 is located in the second communications network 102, that is, the VPLMN, the second node 112 may not send the subscription request towards the fourth node 114. Instead, the second node 112 may respond to the first node 111 with a successful response and a new cause code/indication “UE is registered in a VPLMN”. The new indication may be forwarded by the first node 111 to the third node 113 to inform the third node 113 that the event may not be reported until the device 130 is in the first communications network 101, that is, the HPLMN.

In the first group of embodiments, with the proviso the third node 113 may lack permission for roaming exposure, the second indication may explicitly indicate the third node 113 may lack permission for roaming exposure. In some of such embodiments, the third indication may indicate the device 130 may be roaming and may lack permission to receive the notification.

For example, if the device 130 is located in a non-allowed VPLMN, e.g., not whitelisted or blacklisted, the second node 112 may not send the subscription towards the fourth node 114 and may respond successfully to the first node 111 but may include a new cause code indicating that reporting of exposure information is not-allowed from the VPLMN the device 130 is connected from. That is, the cause code may indicate that event reporting is not going to be performed until the device 130 may returns to the first communications network 101 or may move to an allowed roaming communications network.

In the second group of embodiments, with the proviso the third node 113 may have permission to receive the notification indicating the exposure to the event while roaming in the first subset of the one or more roaming communications networks 110, the first subset having the number of networks lower than the first threshold, the second indication may indicate at least one of the following. According to the first option a), the third node 113 may have permission to receive the notification indicating the exposure to the event while roaming in at least one of: i) the first subset, as explicitly indicated, ii) the first subset, as pre-configured at the second node 112, and iii) any communications network where the device 130 may be allowed to register for roaming. According to the second option, b) the first request for the second node 112 to perform re-authorization of whether or not the third node 113 may have permission to receive the notification with the proviso the device 130 may roam into a different communications network 103. In some of such embodiments, the third indication may indicate at least one of: i) the received request to receive the notification about the exposure of the event for the device 130 has been successful, ii) the device 130 is roaming in the second communications network 102, and iii) the device 130 is roaming and lacks permission to receive the notification in the second communications network 102.

When the second node 112 may receive the indication of “AF is allowed to receive exposure information from some VPLMNs”, if the fourth node 114 is in a VPLMN, the second node 112 may return a cause code, e.g., “UE is in a VPLMN”, and the VPLMN of the fourth node 114. The second node 112 may not contact the fourth node 114 in the VPLMN yet.

### Action 407

In embodiments wherein the third indication may indicate the device 130 may be roaming in the second communications network 102 and the second identifier of the second communications network 102, the second node 112 may, in this Action 407, receive the fifth indication from the first node 111, based on the sent third indication. The fifth indication may indicate whether or not the third node 113 may have permission to receive the notification. The fifth indication may be based on the one or more agreements.

When the second node 112 may receive the indication of, e.g., “current VPLMN is allowed”, it may contact the fourth node 114 in the VPLMN to request for exposure information, e.g., event exposure.

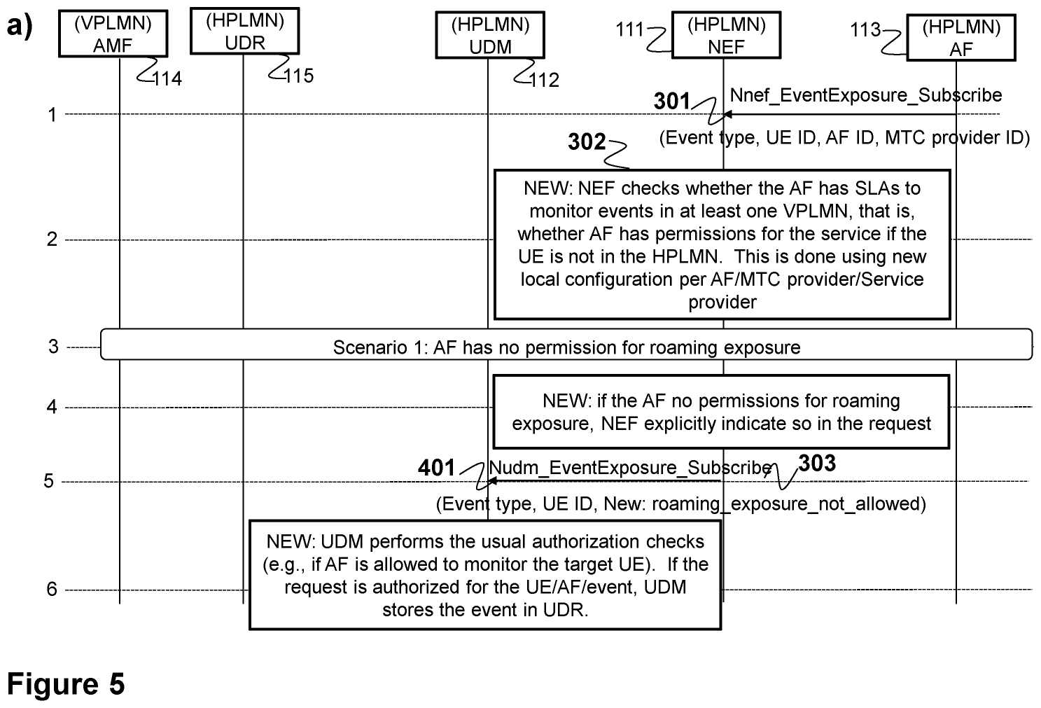

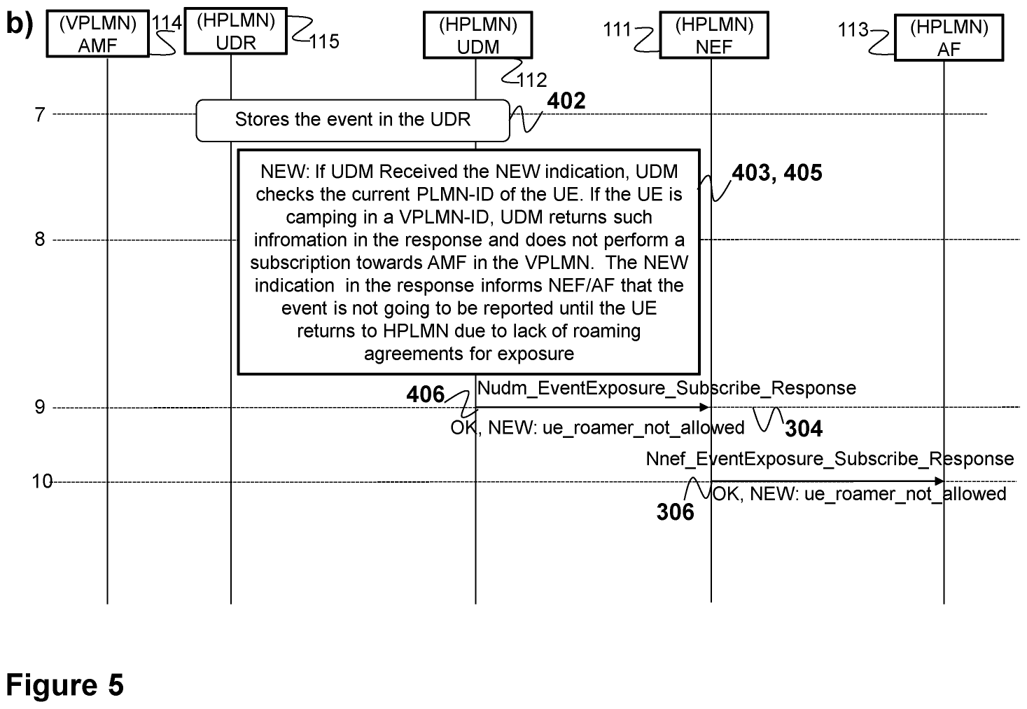

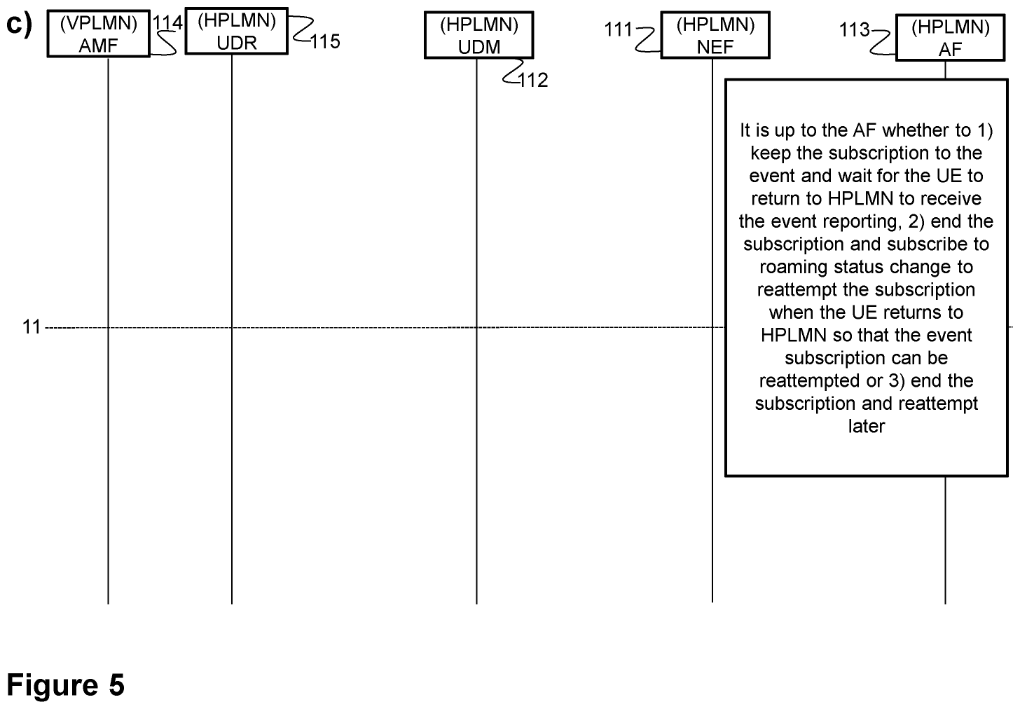

Several non-limiting examples of a method in the communications system 100 according to embodiments herein will now be described in the next FIGS. 5-8. In FIGS. 5-8, the first communications network 101 is the HPLMN, the second communications network 102 is the VPLMN, the first node 111 is a NEF in the HPLMN, the second node 112 is a UDM in the HPLMN, the third node 113 is an AF in the HPLMN, the fourth node 114 is an AMF in the VPLMN, the fifth node 115 is a UDR in the HPLMN, and the device 130 is a UE. It may be understood that in the following examples depicted in FIG. 5-8, any reference to the NEF may be understood to equally refer to the first node 111, any reference to the UDM may be may be understood to equally refer to the second node 112, any reference to the AF may be may be understood to equally refer to the third node 113, any reference to the AMF may be may be understood to equally refer to the fourth node 114, any reference to the UDR may be may be understood to equally refer to the fifth node 115, and any reference to the UE may be may be understood to equally refer to the device 130.

FIG. 5 is a signalling diagram depicting a first non-limiting example of a method performed in the communications system 100, according to embodiments herein, over panels a), b) and c). The example of FIG. 5 depicts a scenario wherein the AF is only allowed to receive exposure information from HPLMN. In Step 1, the AF may subscribe to a given event, e.g., UE location change, for a given UE such as the device 130, which the NEF may receive in accordance with Action 301. The AF may send a Nnef_EventExposure_Subscribe indicating Event type, UE ID, AF ID, and MTC provider ID. In Step 2, based on local configuration, the NEF, in accordance with Action 302, may check the SLAs for the requesting AF. The NEF may check whether the AF may have SLAs to monitor events in at least one VPLMN, that is, whether AF may have permissions for the service if the UE is not in the HPLMN. This may be done using new local configuration per AF/MTC provider/Service provider. The AF may be allowed to receive exposure information: 1) only from the HPLMN; 2) for the HPLMN and some, few, VPLMNs; and 3) from the HPLMN and all VPLMNs except some, few, PLMNs. In the latter cases, the NEF may have the list of VPLMNs blacklisted/whitelisted per AF. The configuration of the list of VPLMNs from which reporting of event exposure information may be allowed may be aligned with the list of VPLMNs the HPLMN may have roaming agreements with. This may be understood to be for the sake of a clean configuration, the list of VPLMNs where reporting of exposure events may be allowed for a given AF may not include a VPLMN for which the HPLMN may not have agreements with. In Steps 3-5, if the AF is only allowed to receive exposure information from the HPLMN, that is, if the AF may not have permission for roaming exposure, the NEF, in accordance with Actions 303 and 401, may include a new indication towards the UDM so that the UDM may not subscribe to the AMF if the AMF is in a VPLMN. If the AF may have no permissions for roaming exposure, the may NEF explicitly indicate so in the request. The NEF may send a Nudm_EventExposure_Subscribe indicating e.g., the Event type, UE ID, and roaming_exposure_not_allowed. The UDM may perform the usual authorization checks, e.g., if the AF is allowed to monitor the target UE. If the request is authorized for the UE/AF/event, the UDM may store the event in the UDR in Step 7, in accordance with Action 402. In Steps 8-10, if the UDM received the new indication, the UDM may check, in accordance with Action 403, the current PLMN-ID of the UE. If the UE is camping in a VPLMN-ID, the UDM may return such information in the response and may not perform a subscription towards the AMF in the VPLMN, in accordance with Action 405. That is, if the AMF currently serving the UE is located in a VPLMN, as determined in accordance with Action 403, the UDM, in accordance with Action 405, may not send the subscription request towards the AMF. Instead, the UDM, in accordance with Actions 406 and 304, may respond to the NEF with a successful response and a new cause code/indication, e.g., “UE is registered in a VPLMN”. The UDM may send a Nudm_EventExposure_Subscribe_Response indicating OK, and ue_roamer_not_allowed. The new indication, in accordance with Action 306, may be forwarded by the NEF to the AF to inform the AF that the event will not be reported until the UE is in a VPLMN. The NEF may send a Nnef_EventExposure_Subscribe_Response indicating OK, and ue_roamer_not_allowed. The new indication in the response may inform the NEF/AF that the event is not going to be reported until the UE may return to the HPLMN due to lack of roaming agreements for exposure. It may be noted that if the AMF currently serving the UE is located in the HPLMN, then the UDM may send the subscription request to the AMF. This is not shown in the figure since the UDM does not check the new indication sent by the NEF in step 5. In Step 11, when the AF receives the indication that, e.g., the “UE is registered in a VPLMN”, it is up to the AF whether to 1) keep the subscription to the event and wait for the UE to return to HPLMN to receive the event reporting, 2) end the subscription and subscribe to roaming status change to reattempt the subscription when the UE returns to HPLMN so that the event subscription may be reattempted or 3) end the subscription and reattempt later.

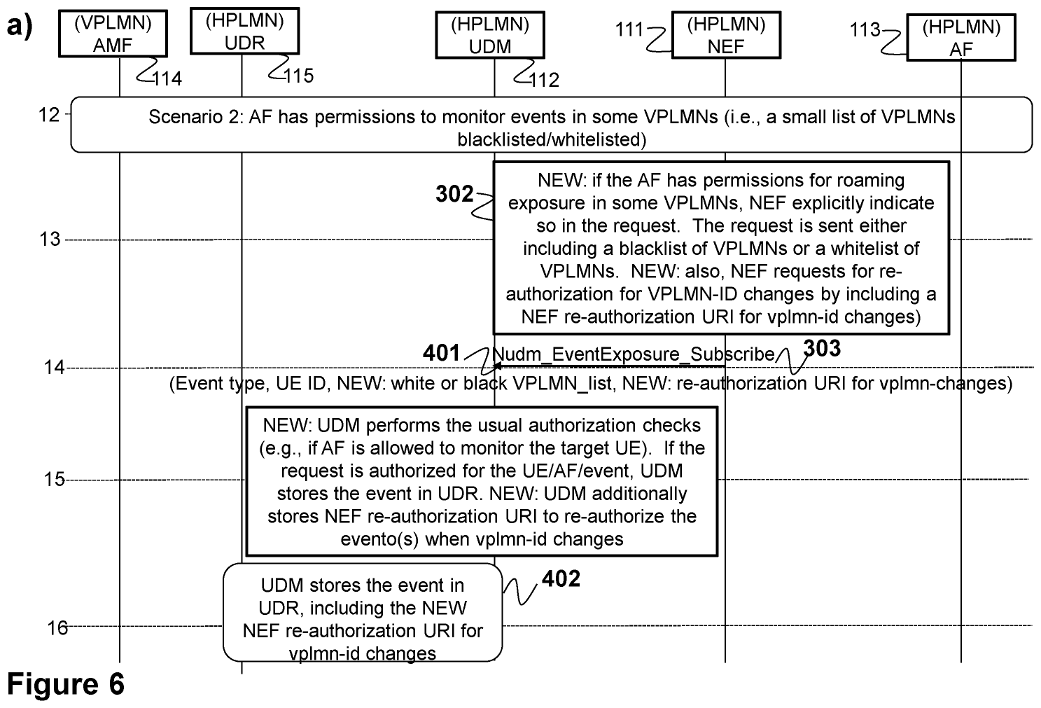

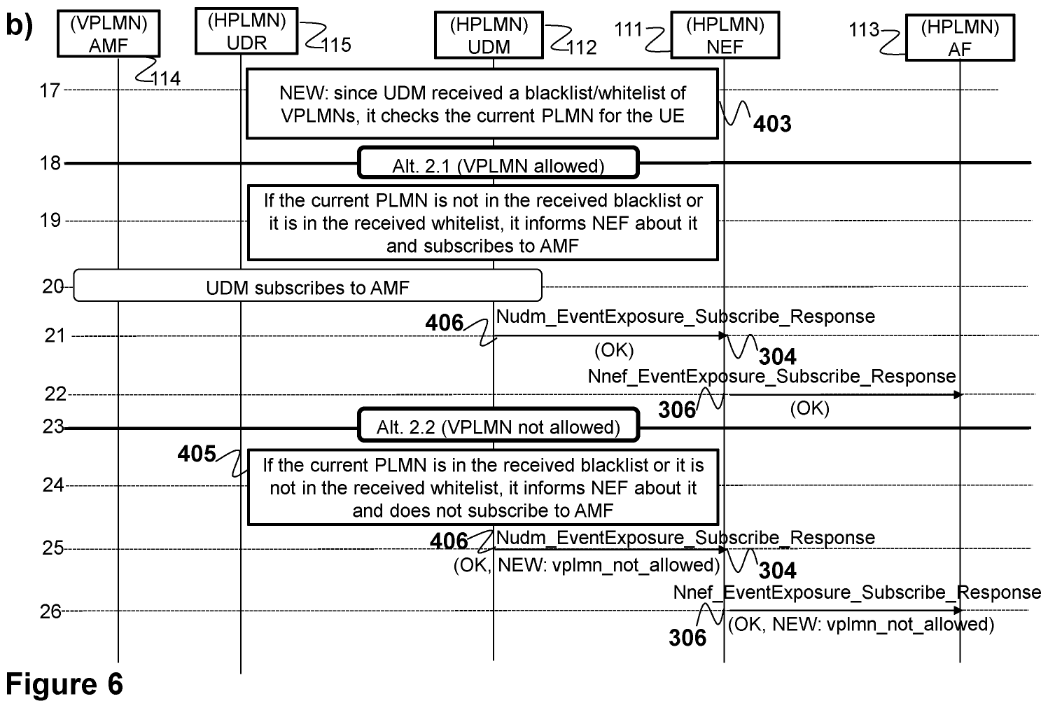

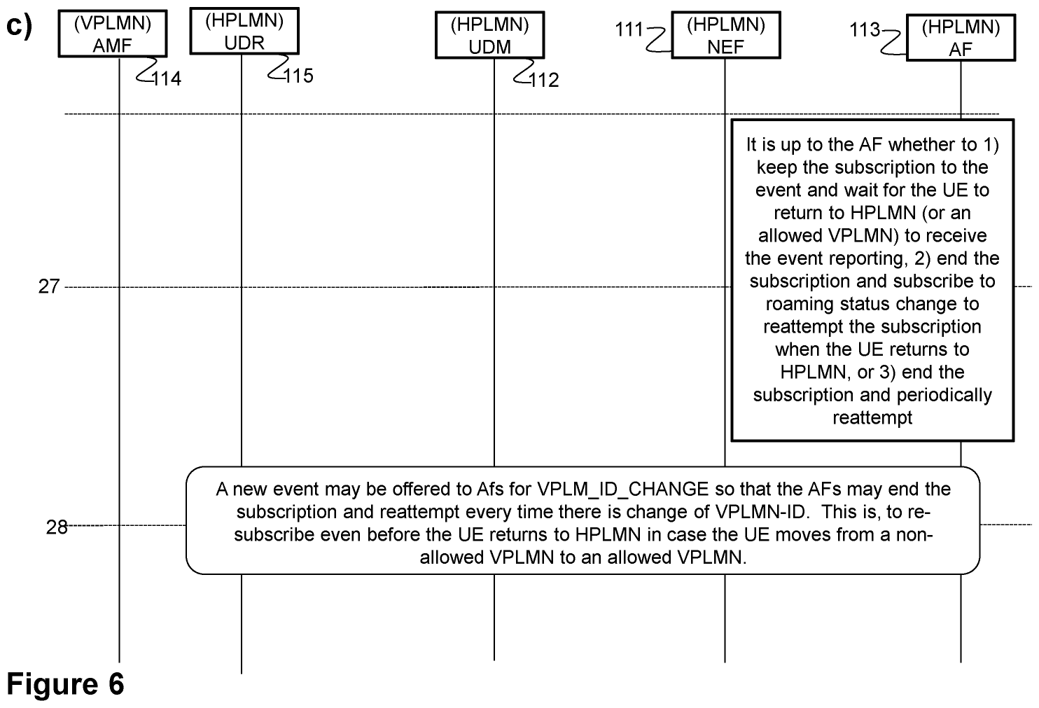

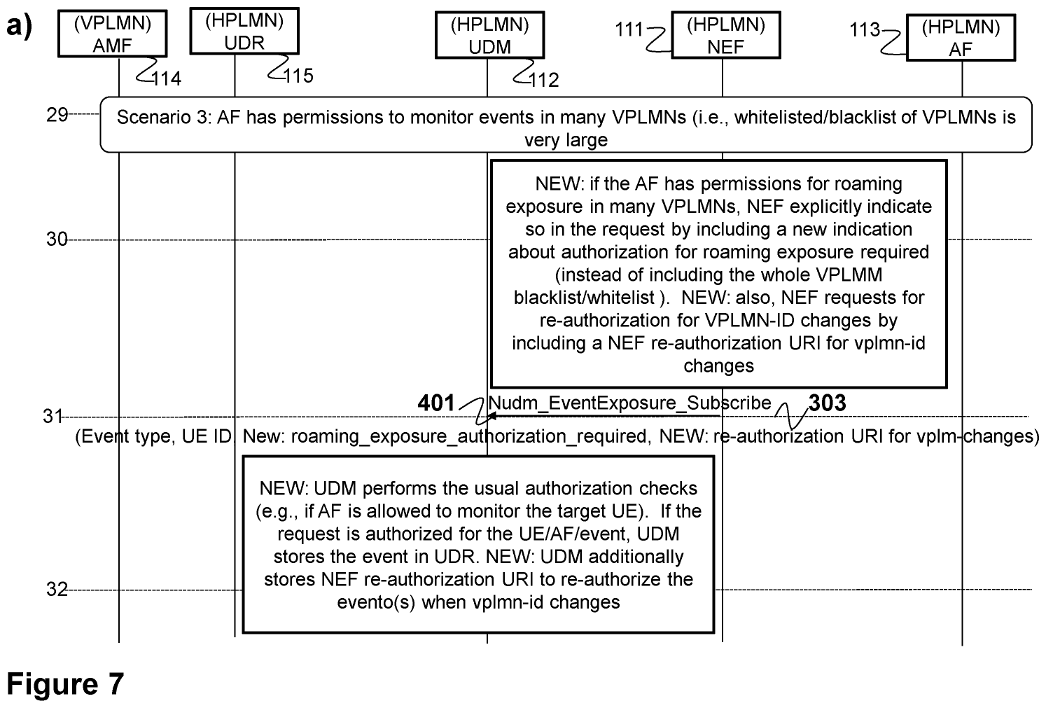

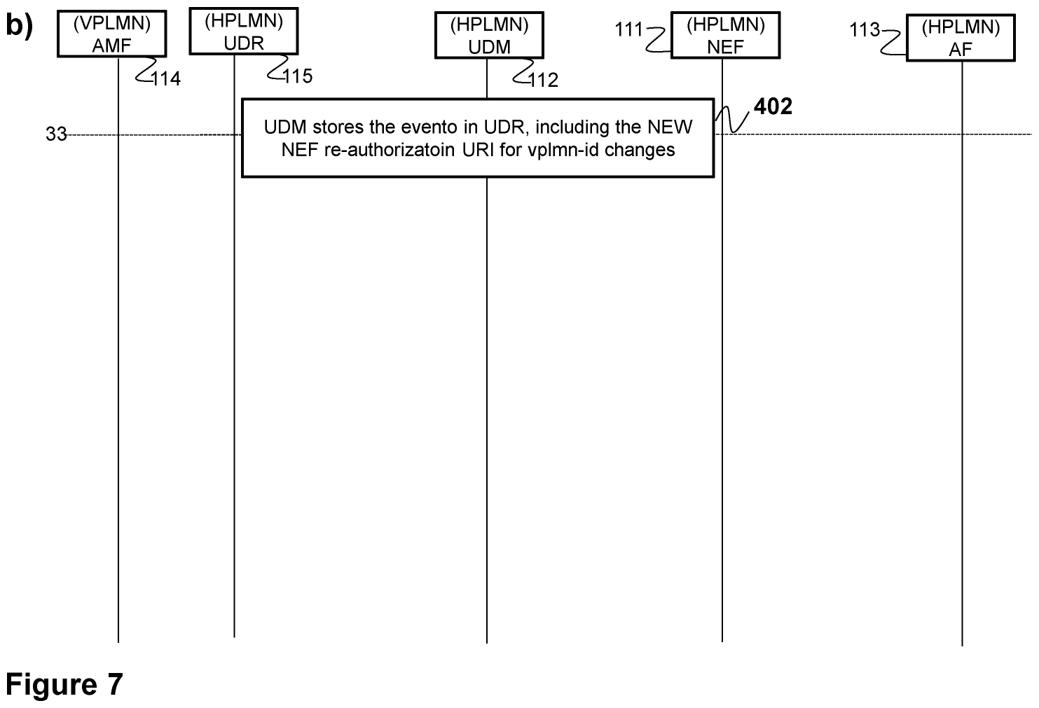

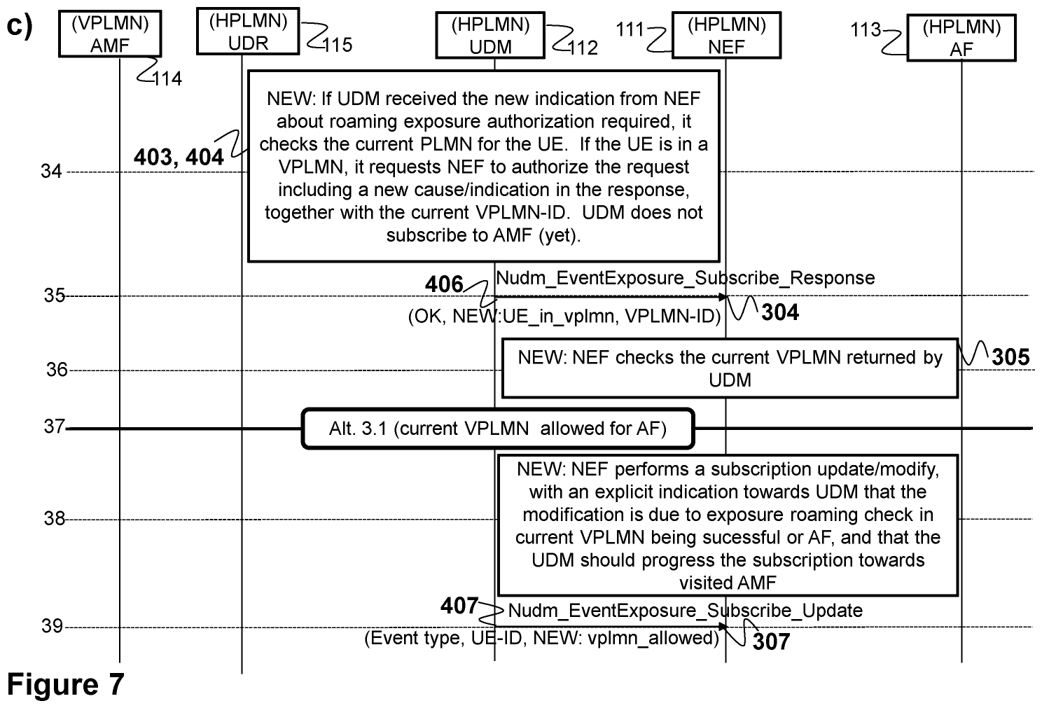

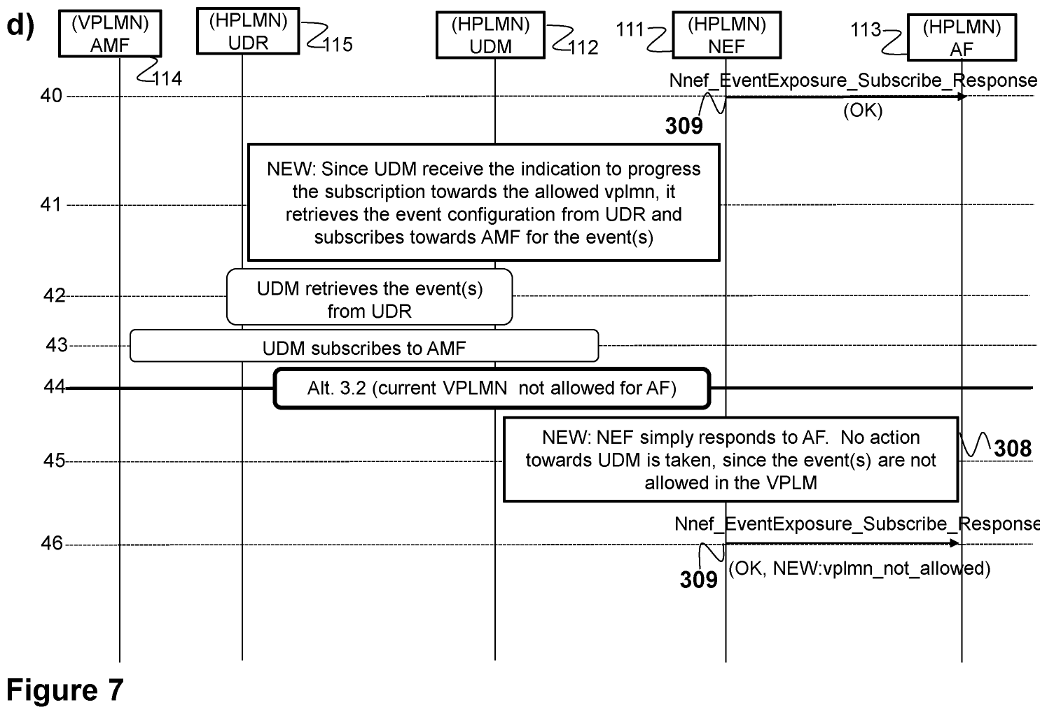

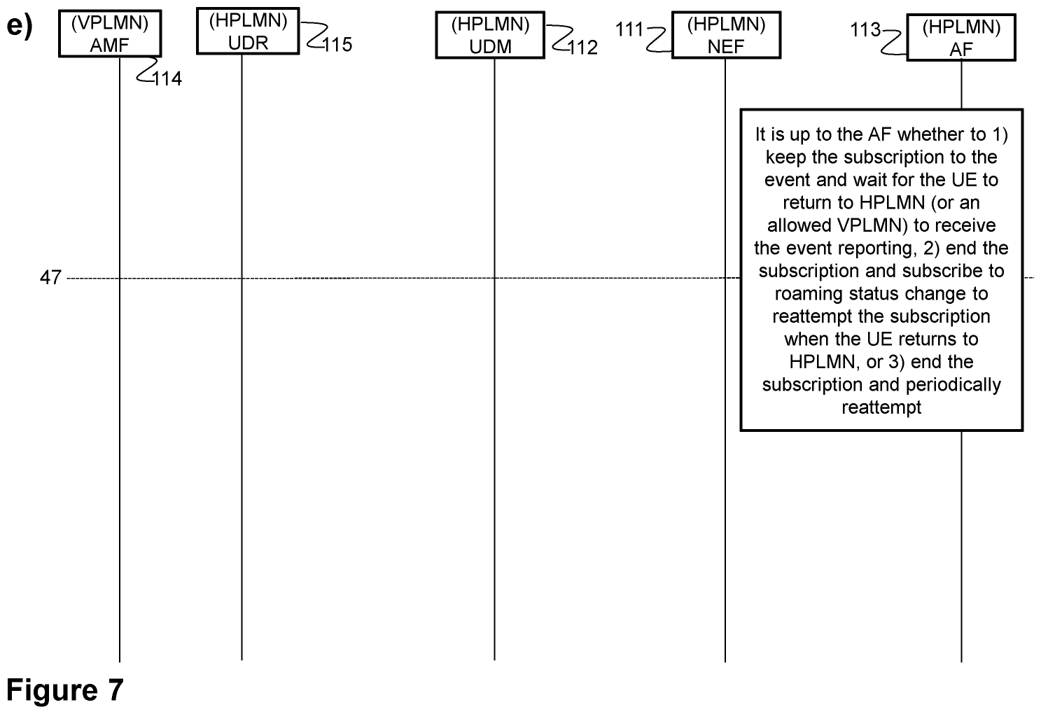

FIG. 6 is another signalling diagram depicting another non-limiting example of a method performed in the communications system 100, according to embodiments herein, over panels a), b) and c). FIG. 6 may be considered a continuation of Step 2 in FIG. 5. The example of FIG. 6 depicts a scenario wherein the AF may be allowed in some, a few, VPLMNs, that is, in the first set, for example, a small list of VPLMNs blacklisted/whitelisted. In Steps 12-14, when the NEF may receive the request from the AF, it may check in accordance with Action 302, whether there the AF may be allowed to receive exposure information from VPLMNs. If the AF has permissions for roaming exposure in some VPLMNs, the NEF may explicitly indicate so in the request. That is, if exposure information from VPLMNs is allowed, the NEF may include in the subscription request sent according to Action 303 one or more of the following. According to one option, a new blacklist/whitelist of VPLMs, if it is fairly small, to inform the UDM that the AF may be allowed to receive exposure information only from those VPLMNs in the whitelist, or that the AF may not be allowed to receive exposure information from those VPLMNs in the blacklist. According to another option, the NEF may request for re-authorization for VPLMN-ID changes by including a new NEF re-authorization URI for vplmn-id changes, so that UDM may use it to re-authorize exposure roaming agreements; that is, the UDM may have to check whether exposure information is allowed from the current VPLMN and at every PLMN-ID change. The NEF may send a Nudm_EventExposure_Subscribe to the UDM indicating, e.g., Event type, UE ID, white or black VPLMN_list, and re-authorization URI for vplmn-changes. The UDM may perform the usual authorization checks, e.g., if AF may be allowed to monitor the target UE. If the request is authorized for the UE/AF/event, the UDM may store the event in UDR, in accordance with Action 402. The UDM may additionally store the NEF re-authorization URI to re-authorize the event(s) when the vplmn-id may change. If both NEF reauthorization URI and blacklist/whitelist of VPLMs are sent to the UDM, it may be up to UDM whether to store in the UDR, according to Action 402, either the URI or the VPLMN list. If the URI is stored, the UDM may have to re-authorize via NEF at every VPLMN-ID where the UE may register. If the UDM stores the list of VPLMNs allowed for exposure for this request, in accordance with Action 402, the UDM may never have to re-authorize via the NEF. Instead, the re-authorization may be solely performed by the UDM. According to yet another option, a new indication, e.g., “all VPLMNs allowed for roaming are also allowed for exposure” may be understood to mean that if the UE is registered in any VPLMN, exposure may be allowed for the request, e.g., for the subscribed event. According to a further option, a new indication, e.g., “default/pre-defined list of VPLMNs allowed for exposure shall be used” may be understood to mean that a new list locally pre-configured in the UDM for exposure agreements may be used for the request. This new list configured may be understood to be a subset of the existing local list of VPLMNs that may be already configured in the UDM for roaming agreements. In Steps 15-17, the UDM may store the event subscription in the UDR, in accordance with Action 402, and may perform the following new actions based on the additional information included by the NEF in the subscription request. According to a first option, if the request from the NEF included a new backlist/whitelist of VPLMNs, the UDM may check, in accordance with Action 403, the received VPLMN list and the current PLMN for the UE and decide whether to send the subscription request to the AMF depending on whether the VPLMN where the UE is registered from may be allowed or not. If the NEF included the blacklist/whitelist but did not include a URI, to avoid the UDM contacting the NEF to re-authorize at VPLMN-ID change, then the UDM may store in UDR the received blacklist/whitelist of VPLMs together, in accordance with Action 402, so that the UDM may check whether each new VPLMN where the UE may register may be allowed for exposure. This may be understood to mean that the UDM may never initiate reauthorization towards the NEF. If, in addition to the blacklist/whitelist, the NEF also included a URI to be used by the UDM to re-authorize exposure roaming agreements via the NEF, the UDM may, in accordance with Action 402, either store this URI in UDR or may store the blacklist/whitelist of VPLMs. This way, depending on what may have been stored in UDR, the UDM may use either the URI to request the NEF to reauthorize, in accordance with Action 404, whether each new VPLMN-ID where the UE may register may be allowed for exposure, or the UDM may use the stored list in UDR and never initiate re-authorization towards NEF at VPLMN-ID change. If the request from the NEF included a new indication, e.g., “all VPLMNs allowed for roaming are also allowed for exposure”, then the UDM may interpret that the HPLMN may enable, for the requesting AF, reporting of exposure information from all the VPLMNs the HPLMN may have roaming agreements with, which may be locally configured in the UDM. That is, all VPLMNs where the UEs may be allowed to be registered by the UDM may also be allowed for exposure. In this case, the UDM may store, in accordance with Action 402, a new indication in the UDR for this request, e.g., “list of allowed VPLMNs and list of allowed VPLMNs for exposure is the same”. This may be understood to mean that the UDM may never initiate reauthorization towards the NEF. According to a second option, if the request from the NEF included a new indication, e.g., “default list of VPLMNs allowed for exposure shall be used”, then the UDM may interpret that the HPLMN may enable that, for the requesting AF, reporting of exposure information may be allowed for all the VPLMNs locally configured in UDM for exposure roaming agreements. This new local list configured in the UDM may be a subset of the existing local list of VPLMNs that may be configured in the UDM for roaming agreements. In this case, the UDM may, in accordance with Action 402, store an additional new indication of, e.g., “default list of VPLMNs allowed for exposure, in the UDR for this request. In this case, the UDM may use the new locally configured list of VPLMNs for exposure roaming agreements. This may be understood to mean that the UDM may never initiate reauthorization towards NEF. According to a third option, if the request from the NEF included only a URI in the NEF in which the UDM may have authorize exposure roaming agreements, the UDM may, in accordance with Action 402, store the URI in UDR. See Steps after FIG. 7 for how the UDM and the NEF may handle this case. This may be understood to mean that the UDM may initiate reauthorization towards the NEF every time the UE may register in a different VPLMN-ID. It may be noted that the information to be included by the NEF may be determined via local configuration on a per AF basis. In Steps 18-22, if the UE is located in the HPLMN or an allowed VPLMN, e.g., the current PLMN may be in the received whitelist or not in the received blacklist, the UDM may send the subscription towards the AMF and, in accordance with Actions 406 and 304, may respond successfully to the NEF as in the baseline. The UDM may send a Nudm_EventExposure_Subscribe_Response with an OK. The NEF may then send the fourth indication to the AF in accordance with Action 306 as a Nnef_EventExposure_Subscribe_Response indicating OK. In Steps 23-28, if the UE is located in a non-allowed VPLMN, e.g., the current PLMN may not be in the received whitelist or may be in the received blacklist, the UDM, in accordance with Action 405, may not send the subscription towards the AMF and, in accordance with Actions 406 and 304, may respond successfully to the NEF but may include a new cause code indicating that reporting of exposure information is not-allowed from the VPLMN the UE is connected from. That is, event reporting is not going to be performed until the UE returns to HPLMN or moves to an allowed VPLMN. The UDM may send a Nudm_EventExposure_Subscribe_Response indicating OK and vplmn_not_allowed. The NEF may then, in accordance to Action 306, send a Nnef_EventExposure_Subscribe_Response indicating OK and vplmn_not_allowed. It may be up to the AF whether to 1) keep the subscription to the event and wait for the UE to return to HPLMN, or an allowed VPLMN, to receive the event reporting, 2) end the subscription and subscribe to roaming status change to reattempt the subscription when the UE returns to HPLMN, or 3) end the subscription and periodically reattempt. A new event may be offered to AFs for VPLM_ID_CHANGE so that the AFs may end the subscription and reattempt every time there may be change of VPLMN-ID. This is, to re-subscribe even before the UE returns to HPLMN in case the UE moves from a non-allowed VPLMN to an allowed VPLMN.

FIG. 7 is a signalling diagram depicting yet another non-limiting example of a method performed in the communications system 100, according to embodiments herein, over panels a), b) and c). The example of FIG. 7 depicts a scenario wherein the AF may be allowed in many VPLMNs, that is, in the second subset. In Steps 29-31, when the NEF may receive the request from the AF, it may check, in accordance with Action 302, whether there the AF may be allowed to receive exposure information from VPLMNs. If the AF has permissions to monitor events in many VPLMNs, e.g., the blacklist/whitelist of VPLMs may be large, the NEF may, in accordance with Actions 303 and 401, explicitly indicate so in the request by including a new indication about authorization for roaming exposure required, instead of including the whole VPLMM blacklist/whitelist. The NEF may include a new indication towards the UDM, e.g., “roaming authorization required” to instruct the UDM that, if the UE is located in a VPLMN, the UDM may not subscribe to the AMF and instead inform the NEF in the response, e.g., the UE is in a VPLMN, together with the VPLMN-ID, so that the NEF may be able to perform authorization checks for the requesting AF and the current VPLMN where the UE may be camping. The NEF may also, request for re-authorization for VPLMN-ID changes by including a NEF re-authorization URI for vplmn-id changes. The NEF may send a Nudm_EventExposure_Subscribe to the UDM indicating, e.g., Event type, UE ID, roaming_exposure_authorization_required, and re-authorization URI for vplm-changes. In Steps 32-35, after storing the event subscription in UDR, in accordance with Action 402, including the URI of NEF for VPLMN-ID authorization, the UDM may, in accordance with Action 403, check the current PLMN the UE may be connected from. The UDM may perform the usual authorization checks, e.g., if the AF may be allowed to monitor the target UE. If the request is authorized for the UE/AF/event, the UDM may, in accordance with Action 402, store the event in the UDR. The UDM may, in accordance with Action 402, additionally store the NEF re-authorization URI to re-authorize the event(s) when the vplmn-id may change. If the UDM received the new indication from the NEF about roaming exposure authorization required, it may check the current PLMN for the UE, in accordance with Action 403. If the UE is in a VPLMN, the UDM may not subscribe to AMF, in accordance with Action 404, and may, in accordance with Actions 406 and 304, respond to the NEF with a request for the NEF to authorize the request including a new cause/indication in the response, e.g., “UE in VPLMN”, together with the current VPLMN-ID. The UDM may send a Nudm_EventExposure_Subscribe_Response indicating e.g., OK, UE_in_vplmn and VPLMN-ID. In Step 36, the NEF, in accordance with Action 305, may check the returned VPLMN-ID by the UDM against the allowed VPLMNs for the requesting AF. In Steps 37-43, if the VPLMN is allowed for the AD, the NEF may, in accordance with Actions 307 and 407, immediately update the subscription with a new indication towards the UDM, e.g., “current VPLMN allowed”, to instruct the UDM to subscribe to the AMF given that UDM may now have confirmation that the request may proceed. The NEF may send a Nudm_EventExposure_Subscribe_Update indicating, e.g., Event type, UE-ID, and vplmn_allowed. The NEF may also, in accordance with Action 309, respond successfully to the AF, since the event reporting may be expected from the current VPLMN. The NEF may send a Nnef_EventExposure_Subscribe_Response indicating OK. Since the UDM may receive the indication to progress the subscription towards the allowed vplmn, the UDM may retrieve the event configuration from the UDR and subscribe towards the AMF for the event(s). The UDM may retrieve the event(s) from the UDR. The UDM may then subscribe to the AMF. In Steps 44-47, if the UE is located in a non-allowed VPLMN for the AF, e.g., not whitelisted or blacklisted, the NEF may respond to the AF successfully but may include a new cause code indicating that the UE is currently in a non-allowed VPLMN. That is, event reporting may not be performed until the UE may return to the HPLMN or may move to an allowed VPLMN. The NEF, in accordance with Action 309, may send a Nnef_EventExposure_Subscribe_Response indicating e.g., OK, vplmn_not_allowed. In accordance with Action 308, no action towards the UDM may be taken, since the event(s) may not be allowed in the VPLM. As before, it may be up to the AF whether to 1) keep the subscription to the event and wait for the UE to return to HPLMN, or an allowed VPLMN, to receive the event reporting, 2) end the subscription and subscribe to roaming status change to reattempt the subscription when the UE returns to HPLMN, or 3) end the subscription and periodically reattempt.

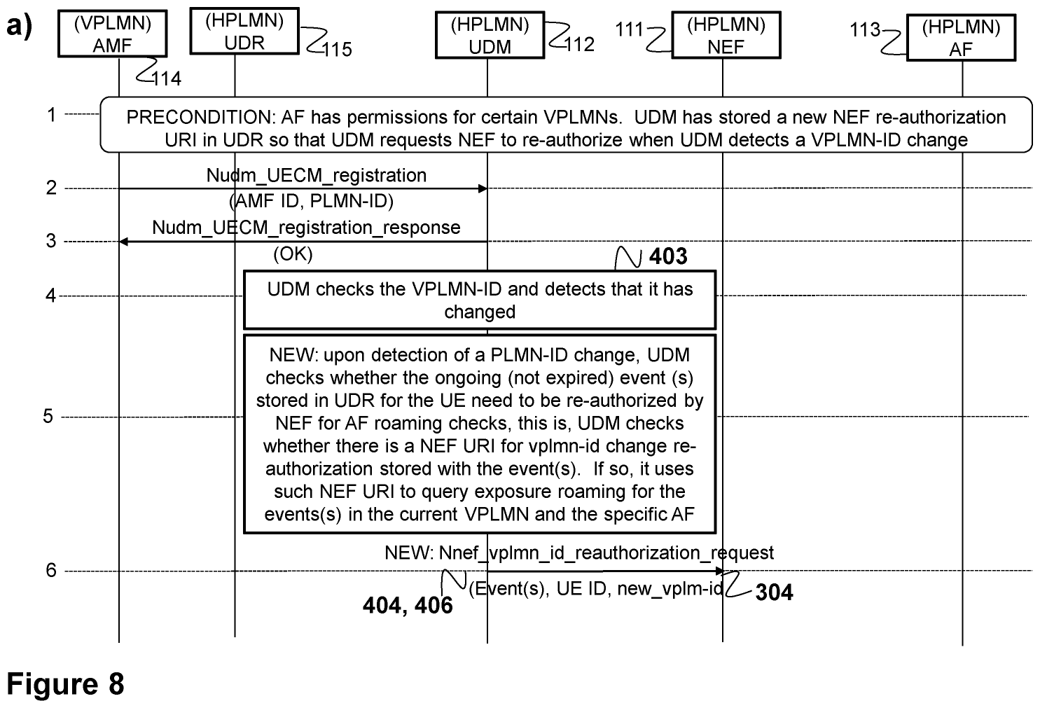

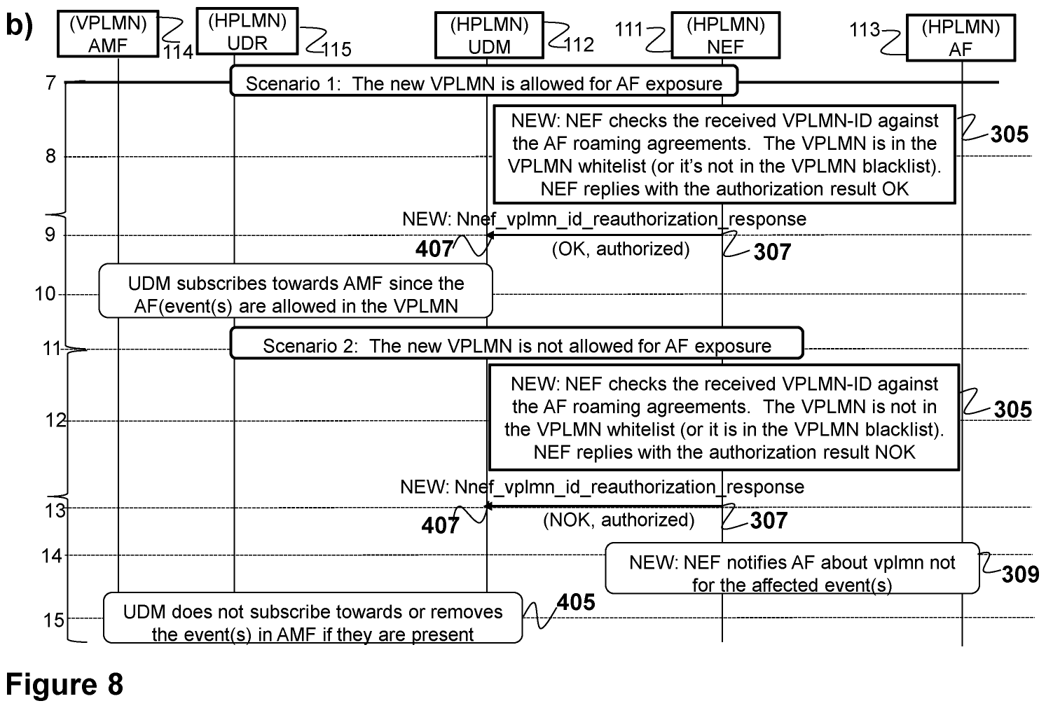

FIG. 8 is a signalling diagram depicting a further non-limiting example of a method performed in the communications system 100, according to embodiments herein. The example of FIG. 8 depicts a scenario wherein there may be a VPLMN change. A precondition may be that the AF may have permissions for certain VPLMNs. The UDM may have stored a new NEF re-authorization URI in the UDR so that the UDM may request the NEF to re-authorize when the UDM may detect a VPLMN-ID change. The AMF of the VPLMN may send a Nudm_UECM_registration to the UDM of the HPLMN indicating AMF ID and PLMN-ID. The UDM may respond by sending a Nudm_UECM_registration_response indicating OK. In Steps 1-6, since the UDM may detect a new reauthorization URI address (NEF) associated to stored event(s) at UE registration, the UDM may check, in accordance with Action 403, whether there may be a change of PLMN-ID. Upon detection of a PLMN-ID change, the UDM may check whether the ongoing, not expired, event(s) stored in the UDR for the UE may need to be re-authorized by the NEF for AF roaming checks. This is, the UDM may check whether there may be a NEF URI for vplmn-id change re-authorization stored with the event(s). If so, the UDM may use such NEF URI to query exposure roaming for the events(s) in the current VPLMN and the specific AF. If the UDM detects a PLMN-ID change, the UDM, in accordance with Actions 404 and 406, may send an authorization request to each URI address. The UDM may send a Nnef_vplmn_id_reauthorization_request indicating e.g., Event(s), UE ID, and the UDM may include the new VPLMN-ID in the authorization request. In Steps 7-10, the NEF may, in accordance with Action 305, check the received VPLMN-ID against the AF roaming agreements. If the reporting of AF exposure information from the received VPLMN is allowed, e.g., the VPLMN is in the VPLMN whitelist, or it is not in the VPLMN blacklist, the NEF in accordance with Actions 307 and 407, may respond with, e.g., an “VPLMN authorized” indication, so that the UDM may subscribe to the AMF since the event(s) are allowed to be reported by the AMF in the VPLMN. The NEF may reply with a Nnef_vplmn_id_reauthorization_response indicating the authorization result OK, authorized. The UDM may then subscribe towards the AMF, since the AF event(s) may be allowed in the VPLMN. In Steps 11-15, the NEF may, in accordance with Action 305, check the received VPLMN-ID against the AF roaming agreements. If the reporting of AF exposure information from the received VPLMN is not allowed, e.g., the VPLMN is not in the VPLMN whitelist, or it is in the VPLMN blacklist, the NEF in accordance with Actions 307 and 407, may respond with an, e.g., “VPLMN not authorized” indication, so that the UDM may remove the event(s) at the new AMF, if required. The NEF may reply with a Nnef_vplmn_id_reauthorization_response indicating the authorization result NOK, authorized. The UDM may, in accordance with Action 405, not subscribe towards the AMF in any case, or remove the event(s) in the AMF if they are present. The NEF may, in accordance with Action 309, include a new cause code in a notification towards the AF indicating that the UE is currently in a non-allowed VPLMN. That is, the event reporting for the affected event(s) is not going to be performed until the UE may return to HPLMN or may move to an allowed VPLMN.

Certain embodiments disclosed herein may provide one or more of the following technical advantage(s), which may be summarized as follows.

As a first advantage, embodiments herein may be understood to enable operators to control in a central manner the exposure information requested to UEs in VPLMNs. Similar to UE existing roaming agreements at UE's registration in 5GC, embodiments herein may be understood to keep also the checks in the second node 112 for exposure roaming agreements, with the help of the first node 111 providing information about the requesting third node 113, e.g., AF/App.

As a first advantage, embodiments herein may be understood to enable to optimize the 5GC signaling, since the exposure information may be disallowed at the first communications network 101, that is, the HPLMN, not at the second communications network 102, e.g., the VPLMN.

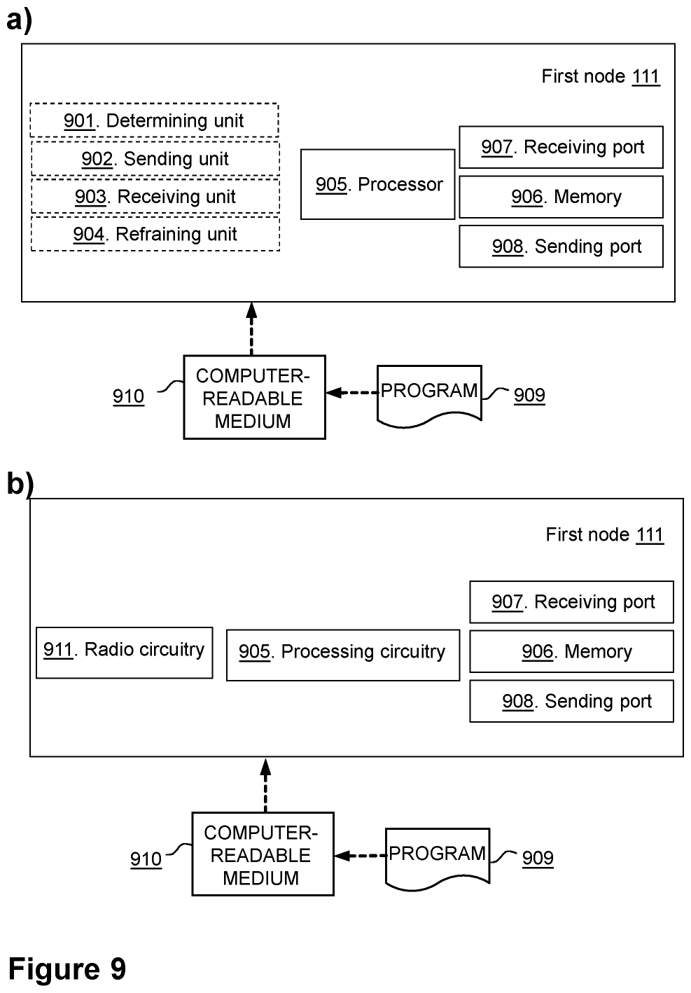

FIG. 9 depicts two different examples in panels a) and b), respectively, of the arrangement that the first node 111 may comprise to perform the method actions described above in relation to FIG. 3 and/or FIGS. 5-8. In some embodiments, the first node 111 may comprise the following arrangement depicted in FIG. 9a. The first node 111 may be understood to be for handling exposure to the event for the device 130. The first node 111 is configured to operate in the first communications network 101. The first communications network 101 is configured to be the home network to the device 130 and to the second node 112.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the first node 111 and will thus not be repeated here. For example, in some embodiments, the first node 111 may be configured to be a NEF, the third node 113 may be configured to be an AF, and the second node 112 may be configured to be a UDM.

The first node 111 is configured to, e.g., by means of a determining unit 901 within the first node 111 configured to, determine whether or not the third node 113 configured to operate in the communications system 100 via the first communications network 101 has permission to receive notifications of the event while the device 130 is roaming in the second communications network 102. The determining is configured to be performed in response to the first indication configured to be received from the third node 113 indicating the request to receive the notification of the event for the device 130. The determining is configured to be based on the one or more agreements of the third node 113 with the first communications network 101 to service the device 130 in the one or more roaming communications networks 110.

The first node 111 is also configured to, e.g., by means of a sending unit 902 within the first node 111 configured to, send the second indication to the second node 112 configured to operate in the first communications network 101. The second indication is configured to indicate the result of the determination.

The first node 111 may be also configured to, e.g., by means of a receiving unit 903 within the first node 111 configured to, receive the first indication from the third node 113.

In some embodiments, the first node 111 may be further configured to, e.g., by means of the receiving unit 903 within the first node 111 configured to, receive the third indication from the second node 112. The third indication may be configured to indicate whether or not the device 130 is roaming. Third indication may be configured to be based on the second indication configured to be sent.

In some embodiments, the first node 111 may be further configured to, e.g., by means of the sending unit 902 within the first node 111 configured to, send the fourth indication to the third node 113. The fourth indication may be configured to be based on the third indication configured to be received. The fourth indication may be configured to indicate whether or not the device 130 is roaming, and whether or not the third node 113 may have permission to receive the notification.

In some embodiments, with the proviso the first node 111 may determine the third node 113 lacks permission for roaming exposure, the second indication may be configured to explicitly indicate the third node 113 lacks permission for roaming exposure, the third indication may be configured to indicate the device 130 is roaming and the third node 113 lacks permission to receive the notification while the device 130 is roaming, and the fourth indication may be configured to indicate the device 130 is roaming and the third node 113 lacks permission to receive the notification.

In some embodiments, with the proviso the third node 113 may have permission to receive the notification configured to indicate the exposure to the event while roaming in the first subset of the one or more roaming communications networks 110, the first subset being configured to have the number of networks lower than the first threshold, the second indication may be configured to indicate at least one of: a) the third node 113 has permission to receive the notification configured to indicate the exposure to the event while roaming in at least one of: i) the first subset, as configured to be explicitly indicated, ii) the first subset, as configured to be pre-configured at the second node 112, and iii) any communications network where the device 130 may be configured to be allowed to register for roaming, and b) the first request for the second node 112 to perform re-authorization of whether or not the third node 113 has permission to receive the notification with the proviso the device 130 roams into a different communications network 103. In these embodiments, the third indication and the fourth indication may be configured to indicate at least one of: i) the received request to receive the notification about the exposure of the event for the device 130 has been successful, ii) the device 130 is roaming in the second communications network 102, and iii) the device 130 is roaming and lacks permission to receive the notification in the second communications network 102.

In some embodiments, with the proviso the third node 113 may have permission to receive the notification configured to indicate the exposure to the event while roaming in the second subset of the one or more roaming communications networks 110, the second subset being configured to have the number of networks exceeding the second threshold, the second indication may be configured to indicate the indicator. The indication may be of the endpoint in the first node 111 the second node 112 may have to use to perform re-authorization with the first node 111. The re-authorization may be of whether or not the third node 113 may have permission to receive the notification of the event while the device 130 may be roaming in the second communications network 102. The second communications network 102 may be configured to be comprised in the second subset. The re-authorization may be configured to be to be performed with the proviso the device 130 may roam into a different communications network 103.

In some embodiments, the second indication may be further configured to indicate the first request for the second node 112 to perform the re-authorization.

In some embodiments, the third indication may be configured to indicate one of: i) the device 130 is roaming in the second communications network 102 and the first identifier of the second communications network 102, and ii) the received request to receive the notification of the event for the device 130 has been successful.

In some embodiments wherein the third indication may be configured to indicate the device 130 is roaming in the second communications network 102 and the first identifier of the second communications network 102, the first node 111 may be further configured to, e.g., by means of the determining unit 901 within the first node 111 configured to, determine whether or not the third node 113 may have permission to receive the notification configured to indicate the exposure to the event while the device 130 may be roaming in the second communications network 102. The determining may be configured to be performed in response to the third indication configured to be received from the second node 112. The determining may be configured to be based on the one or more agreements.

In some embodiments wherein the third indication may be configured to indicate the device 130 is roaming in the second communications network 102 and the first identifier of the second communications network 102, the first node 111 may be further configured to, e.g., by means of the sending unit 902 within the first node 111 configured to, send the sixth indication to the third node. The sixth indication may be configured to indicate the result of the determination configured to be performed based on the third indication configured to be received, and one of the next two configurations.

In some embodiments wherein the third indication may be configured to indicate the device 130 is roaming in the second communications network 102 and the first identifier of the second communications network 102, the first node 111 may be further configured to, e.g., by means of the sending unit 902 within the first node 111 configured to, send the fifth indication to the second node 112. The fifth indication may be configured to indicate the result of the determination configured to be performed based on the third indication configured to be received.

Alternatively, in some embodiments wherein the third indication may be configured to indicate the device 130 is roaming in the second communications network 102 and the first identifier of the second communications network 102, the first node 111 may be configured to, e.g., by means of a refraining unit 904 within the first node 111 configured to, refrain from sending the fifth indication to the second node 112, with the proviso the first node 111 determines the third node 113 lacks permission to receive the notification.

In some embodiments, the one or more agreements to receive service may be configured to be the one or more SLAs.

In some embodiments, the determining of whether or not the third node 113 may have permission to receive notification indicating the exposure to the event while the device 130 may be roaming in the second communications network 102 may be configured to be performed per at least one of: application function, type of event, identifier of the device 130 and service provider.

The embodiments herein may be implemented through one or more processors, such as a processor 905 in the first node 111 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 906 comprising one or more memory units. The memory 906 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, the device 130 and/or another node through a receiving port 907. In some examples, the receiving port 907 may be, for example, connected to one or more antennas in the first node 111. In other embodiments, the first node 111 may receive information from another structure in the communications system 100 through the receiving port 907. Since the receiving port 907 may be in communication with the processor 905, the receiving port 907 may then send the received information to the processor 905. The receiving port 907 may also be configured to receive other information.

The processor 905 in the first node 111 may be further configured to transmit or send information to e.g., the second node 112, the third node 113, the fourth node 114, the fifth node 115, the device 130, another node and/or another structure in the communications system 100, through a sending port 908, which may be in communication with the processor 905, and the memory 906.

Those skilled in the art will also appreciate that any of the units 901-904 described above may refer to a combination of analog and digital circuits, and/or one or more processors configured with software and/or firmware, e.g., stored in memory, that, when executed by the one or more processors such as the processor 905, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 901-904 described above may be the processor 905 of the first node 111, or an application running on such processor.

Thus, the methods according to the embodiments described herein for the first node 111 may be respectively implemented by means of a computer program 909 product, comprising instructions, i.e., software code portions, which, when executed on at least one processor 905, cause the at least one processor 905 to carry out the actions described herein, as performed by the first node 111. The computer program 909 product may be stored on a computer-readable storage medium 910. The computer-readable storage medium 910, having stored thereon the computer program 909, may comprise instructions which, when executed on at least one processor 905, cause the at least one processor 905 to carry out the actions described herein, as performed by the first node 111. In some embodiments, the computer-readable storage medium 910 may be a non-transitory computer-readable storage medium, such as a CD ROM disc, a memory stick, or stored in the cloud space. In other embodiments, the computer program 909 product may be stored on a carrier containing the computer program, wherein the carrier is one of an electronic signal, optical signal, radio signal, or the computer-readable storage medium 910, as described above.

The first node 111 may comprise an interface unit to facilitate communications between the first node 111 and other nodes or devices, e.g., the second node 112, the third node 113, the fourth node 114, the fifth node 115, the device 130, another node and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 9b. The first node 111 may comprise a processing circuitry 905, e.g., one or more processors such as the processor 905, in the first node 111 and the memory 906. The first node 111 may also comprise a radio circuitry 911, which may comprise e.g., the receiving port 907 and the sending port 908. The processing circuitry 905 may be configured to, or operable to, perform the method actions according to FIG. 3 and/or FIGS. 5-8, in a similar manner as that described in relation to FIG. 9a. The radio circuitry 911 may be configured to set up and maintain at least a wireless connection with the second node 112, the third node 113, the fourth node 114, the fifth node 115, the device 130, another node and/or another structure in the communications system 100.

Hence, embodiments herein also relate to the first node 111 operative for handling exposure to the event for the device 130, the first node 111 being operative to operate in the first communications network 101, wherein the first communications network 101 is the home network to the device 130 and to the second node 112. The first node 111 may comprise the processing circuitry 905 and the memory 906, said memory 906 containing instructions executable by said processing circuitry 905, whereby the first node 111 is further operative to perform the actions described herein in relation to the first node 111, e.g., in FIG. 3 and/or FIGS. 5-8.

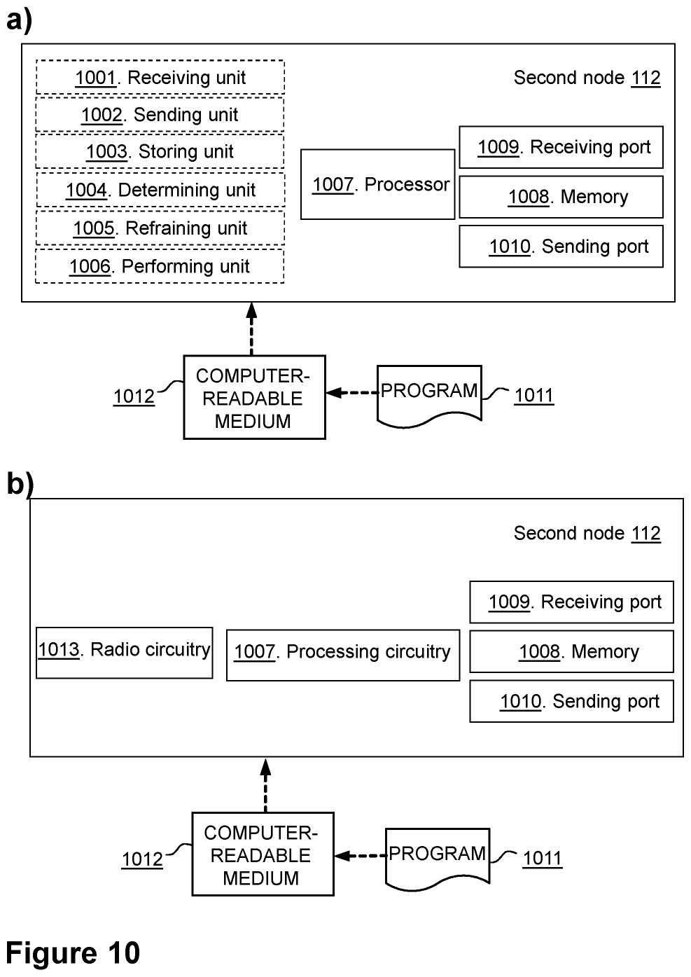

FIG. 10 depicts two different examples in panels a) and b), respectively, of the arrangement that the second node 112, may comprise to perform the method actions described above in relation to FIG. 4 and/or FIGS. 5-8. In some embodiments, the second node 112 may comprise the following arrangement depicted in FIG. 10a. The second node 112 may be understood to be for handling exposure to the event for the device 130. The second node 112 is configured to operate in the first communications network 101. The first communications network 101 is configured to be the home network to the device 130.

Several embodiments are comprised herein. Components from one embodiment may be tacitly assumed to be present in another embodiment and it will be obvious to a person skilled in the art how those components may be used in the other exemplary embodiments. In FIG. 10, optional boxes are indicated by dashed lines. The detailed description of some of the following corresponds to the same references provided above, in relation to the actions described for the second node 112 and will thus not be repeated here. For example, in some embodiments, the first node 111 may be configured to be a NEF, the third node 113 may be configured to be an AF, and the second node 112 may be configured to be a UDM.

The second node 112 is configured to, e.g., by means of a receiving unit 1001 within the second node 112 configured to, receive the second indication from the first node 111 configured to operate in the first communications network 101. The second indication is configured to indicate whether or not the third node 113 configured to operate in the communications system 100 via the first communications network 101 has permission to receive notifications of the event while the device 130 is roaming in the second communications network 102. The second indication is configured to operate based on the one or more agreements of the third node 113 with the first communications network 101 to service the device 130 in the one or more roaming communications networks 110.

The second node 112 is also configured to, e.g., by means of a sending unit 1002 within the second node 112 configured to, send the third indication to the first node 111. The third indication is configured to indicate whether or not the device 130 is roaming, and the third indication is configured to be based on the second indication configured to be sent.

The second node 112 may also be configured to, e.g., by means of a storing unit 1003 within the second node 112 configured to, store the second indication.

The second node 112 may also be configured to, e.g., by means of a determining unit 1004 within the second node 112 configured to, determine which communications network the device 130 may be registered with.

With the proviso the second node 112 may determine the device 130 is roaming, from the first communications network 101 in the second communications network 102, the second node 112 may be further configured to, e.g., by means of a refraining unit 1005 within the second node 112 configured to, refrain from sending the request to receive the notification configured to indicate the exposure to the event to the fourth node 114 in the second communications network 102.

In some embodiments, with the proviso the third node 113 may lack permission for roaming exposure, the second indication may be configured to explicitly indicate the third node 113 lacks permission for roaming exposure, and the third indication may be configured to indicate the device 130 is roaming and lacks permission to receive the notification.

In some embodiments, with the proviso the third node 113 may have permission to receive the notification indicating the exposure to the event while roaming in the first subset of the one or more roaming communications networks 110, the first subset may be configured to have the number of networks lower than the first threshold, the second indication may be configured to indicate at least one of: a) the third node 113 has permission to receive the notification configured to indicate the exposure to the event while roaming in at least one of: i) the first subset, as configured to be explicitly indicated, ii) the first subset, as pre-configured at the second node 112, and iii) any communications network where the device 130 may be configured to be allowed to register for roaming, and b) the first request for the second node 112 to perform re-authorization of whether or not the third node 113 may have permission to receive the notification with the proviso the device 130 roams into a different communications network 103. In some of these embodiments, the third indication may be configured to indicate at least one of: i) the received request to receive the notification about the exposure of the event for the device 130 has been successful, ii) the device 130 is roaming in the second communications network 102, and iii) the device 130 is roaming and lacks permission to receive the notification in the second communications network 102.

In some embodiments one of the following options may apply. According to a first option, with the proviso the second indication may lack the first request to perform re-authorization, the second node 112 may be configured to store the second indication and the determining may be further configured to comprise determining whether the communications network the device 130 is registered with is allowed for exposure. According to a second option, with the proviso the second indication may be configured to comprise the first request to perform re-authorization, the storing may be configured to comprise storing at least one of: the first request and the first subset, and the second node 112 may be further configured to e.g., by means of a performing unit 1006 within the second node 112 configured to, optionally, perform re-authorization with the first node 111 of whether or not the third node 113 may have permission to receive the notification with the proviso the device 130 may roam into a different communications network 103. According to a third option, with the proviso the second indication may be configured to indicate the third node 113 may have permission to receive the notification while roaming in the first subset, as pre-configured at the second node 112 or in any communications network where the device 130 may be configured to be allowed to register for roaming, the second node 112 may be configured to refrain from performing the re-authorization. According to a fourth option, with the proviso the second indication may be configured to only comprise the first request to perform re-authorization, the storing may be configured to comprise storing the first request and second node 112 may be configured to perform the re-authorization.

In some embodiments, with the proviso the third node 113 may have permission to receive the notification indicating the exposure to the event while roaming in the second subset of the one or more roaming communications networks 110, the second subset being configured to have the number of networks exceeding the second threshold, the second indication may be configured to indicate the indicator. The indicator may be of the endpoint in the first node 111 the second node 112 may have to use to perform re-authorization with the first node 111. The re-authorization may be of whether or not the third node 113 may have permission to receive the notification indicating the exposure to the event while the device 130 may be roaming in the second communications network 102. The second communications network 102 may be configured to be comprised in the second subset. The re-authorization may be configured to be to be performed with the proviso the device 130 may roam into a different communications network 103.

In some embodiments, the second indication may be further configured to indicate the first request for the second node 112 to perform the re-authorization.

In some embodiments, the third indication may be configured to indicate one of: i) the device 130 is roaming in the second communications network 102, and ii) the received request to receive the notification about the exposure of the event for the device 130 has been successful.

In some embodiments, wherein the third indication may be configured to indicate the device 130 is roaming in the second communications network 102 and the first identifier of the second communications network 102, the second node 112 may be further configured to, e.g., by means of the receiving unit 1001 within the second node 112 further configured to, receive the fifth indication from the first node 111, based on the third indication configured to be sent. The fifth indication may be configured to indicate whether or not the third node 113 may have permission to receive the notification. The fifth indication may be configured to be based on the one or more agreements.

In some embodiments, the one or more agreements to receive service may be configured to be the one or more SLAs.

In some embodiments, the determining of whether or not the third node 113 may have permission to receive notification indicating the exposure to the event while the device 130 may be roaming in the second communications network 102 may be configured to be performed per at least one of: application function, type of event, identifier of the device 130 and service provider.

The embodiments herein may be implemented through one or more processors, such as a processor 1007 in the second node 112 depicted in FIG. 10, together with computer program code for performing the functions and actions of the embodiments herein. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1008 comprising one or more memory units. The memory 1008 is arranged to be used to store obtained information, store data, configurations, schedulings, and applications etc. to perform the methods herein when being executed in the second node 112.

In some embodiments, the second node 112 may receive information from, e.g., the first node 111, the third node 113, the fourth node 114, the fifth node 115, the device 130, and/or another node, through a receiving port 1009. In some examples, the receiving port 1009 may be, for example, connected to one or more antennas in the second node 112. In other embodiments, the second node 112 may receive information from another structure in the communications system 100 through the receiving port 1009. Since the receiving port 1009 may be in communication with the processor 1007, the receiving port 1009 may then send the received information to the processor 1007. The receiving port 1009 may also be configured to receive other information.

The processor 1007 in the second node 112 may be further configured to transmit or send information to e.g., the first node 111, the third node 113, the fourth node 114, the fifth node 115, the device 130, another node and/or another structure in the communications system 100, through a sending port 1010, which may be in communication with the processor 1007, and the memory 1008.

Those skilled in the art will also appreciate that any of the units 1001-1006 described above may refer to a combination of analog and digital circuits, and/or one or more processors configured with software and/or firmware, e.g., stored in memory, that, when executed by the one or more processors such as the processor 1007, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1001-1006 described above may be the processor 1007 of the second node 112, or an application running on such processor.

Thus, the methods according to the embodiments described herein for the second node 112 may be respectively implemented by means of a computer program 1011 product, comprising instructions, i.e., software code portions, which, when executed on at least one processor 1007, cause the at least one processor 1007 to carry out the actions described herein, as performed by the second node 112. The computer program 1011 product may be stored on a computer-readable storage medium 1012. The computer-readable storage medium 1012, having stored thereon the computer program 1011, may comprise instructions which, when executed on at least one processor 1007, cause the at least one processor 1007 to carry out the actions described herein, as performed by the second node 112. In some embodiments, the computer-readable storage medium 1012 may be a non-transitory computer-readable storage medium, such as a CD ROM disc, a memory stick, or stored in the cloud space. In other embodiments, the computer program 1011 product may be stored on a carrier containing the computer program, wherein the carrier is one of an electronic signal, optical signal, radio signal, or the computer-readable storage medium 1012, as described above.

The second node 112 may comprise an interface unit to facilitate communications between the second node 112 and other nodes or devices, e.g., the first node 111, the third node 113, the fourth node 114, the fifth node 115, the device 130, another node and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 10b. The second node 112 may comprise a processing circuitry 1007, e.g., one or more processors such as the processor 1007 in the second node 112 and the memory 1008. The second node 112 may also comprise a radio circuitry 1013, which may comprise e.g., the receiving port 1009 and the sending port 1010. The processing circuitry 1007 may be configured to, or operable to, perform the method actions according to FIG. 4 and/or FIGS. 5-8, in a similar manner as that described in relation to FIG. 10a. The radio circuitry 1013 may be configured to set up and maintain at least a wireless connection with the first node 111, the third node 113, the fourth node 114, the fifth node 115, the device 130, another node and/or another structure in the communications system 100.

Hence, embodiments herein also relate to the second node 112 operative for handling information, the second node 112 being operative to operate in the communications system 100. The second node 112 may comprise the processing circuitry 1007 and the memory 1008, said memory 1008 containing instructions executable by said processing circuitry 1007, whereby the second node 112 is further operative to perform the actions described herein in relation to the second node 112, e.g., in FIG. 4 and/or FIGS. 5-8.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of: ” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP TS 23.501 version 17.3.0: System architecture for the 5G System (5GS)
2. 3GPP TS 23.502 version 17.3.0: Procedures for the 5G System (5GS)

1. A computer-implemented method, performed by a first node, for handling exposure to an event for a device, the first node operating in a first communications network, the first communications network is being a home network to the device and to a second node, the method comprising:
receiving a first indication from a third node;
determining whether or not the third node operating in a communications system via the first communications network has permission to receive notifications of the event while the device is roaming in a second communications network, the determining being performed in response to the first indication received from the third node indicating a request to receive a notification of the event for the device, and wherein the determining is based on one or more agreements of the third node with the first communications network to service the device in one or more roaming communications networks;
sending a second indication to the second node operating in the first communications network, the second indication indicating a result of the determination;
receiving a third indication from the second node, the third indication indicating whether or not the device is roaming, and the third indication being based on the sent second indication; and
sending a fourth indication to the third node, the fourth indication being based on the received third indication, the fourth indication indicating whether or not the device is roaming, and whether or not the third node has permission to receive the notification.

2. (canceled)

3. The computer-implemented method according to claim 1, wherein with a proviso that the first node determines the third node lacks permission for roaming exposure, the second indication explicitly indicates the third node lacks permission for roaming exposure, the third indication indicates the device is roaming and the third node lacks permission to receive the notification while the device is roaming, and wherein the fourth indication indicates the device is roaming and the third node lacks permission to receive the notification.

4. The computer-implemented method according to claim 3, wherein with a proviso that the third node has permission to receive the notification indicating the exposure to the event while roaming in a first subset of the one or more roaming communications networks, the first subset having a number of networks lower than a first threshold, wherein the second indication indicates at least one of:
the third node has permission to receive the notification indicating the exposure to the event while roaming in at least one of:
the first subset, as explicitly indicated;
the first subset, as pre-configured at the second node; and
any communications network where the device is allowed to register for roaming; and
a first request for the second node to perform re-authorization of whether or not the third node has permission to receive the notification with the proviso the device roams into a different communications network; and
wherein the third indication and the fourth indication indicate at least one of:
the received request to receive the notification about the exposure of the event for the device has been successful;
the device is roaming in the second communications network; and
the device is roaming and lacks permission to receive the notification in the second communications network.

5. The computer-implemented method according to claim 3, wherein with a proviso that the third node has permission to receive the notification indicating the exposure to the event while roaming in a second subset of the one or more roaming communications networks, the second subset having a number of networks exceeding a second threshold, the second indication indicates an indicator of an endpoint in the first node the second node is to use to perform re-authorization with the first node of whether or not the third node has permission to receive the notification of the event while the device is roaming in the second communications network, the second communications network being comprised in the second subset, and wherein the re-authorization is to be performed with a proviso that the device roams into a different communications network.

6. The computer-implemented method according to claim 5, wherein the second indication further indicates a first request for the second node to perform the re-authorization.

7. The computer-implemented method according to claim 4, wherein the third indication indicates one of:
the device is roaming in the second communications network and a first identifier of the second communications network; and
the received request to receive the notification of the event for the device has been successful.

8. The computer-implemented method according to claim 7, wherein the third indication indicates the device is roaming in the second communications network and the first identifier of the second communications network, and wherein the method further comprises:
determining whether or not the third node has permission to receive the notification indicating the exposure to the event while the device is roaming in the second communications network, the determining being performed in response to the third indication received from the second node, and wherein the determining is based on the one or more agreements;
sending a sixth indication to the third node, the sixth indication indicating a result of the determination performed based on the received third indication; and one of:
sending a fifth indication to the second node, the fifth indication indicating the result of the determination performed based on the received third indication; or
refraining from sending the fifth indication to the second node, with a proviso that the first node determines the third node lacks permission to receive the notification.

9. The computer-implemented method according to claim 1, wherein the first node is a Network Exposure Function, NEF, the third node is an Application Function, AF, and the second node is a Unified Data Management, UDM; or
wherein the one or more agreements to receive service are one or more Service Level Agreements, SLAs; or
wherein the determining of whether or not the third node has permission to receive notification indicating the exposure to the event while the device is roaming in the second communications network is performed per at least one of: application function, type of event, identifier of the device and service provider.

10. (canceled)

11. (canceled)

12. A computer-implemented method, performed by a second node, for handling exposure to an event for a device, the second node operating in a first communications network, the first communications network being a home network to the device, the method comprising:
receiving a second indication from a first node operating in the first communications network, the second indication indicating whether or not a third node operating in a communications system via the first communications network has permission to receive notifications of the event while the device is roaming in a second communications network, the second indication being dependent on a response to a first indication received by the first node from the third node indicating a request to receive a notification of the event for the device, the second indication being based on one or more agreements of the third node with the first communications network to service the device in one or more roaming communications networks, storing the second indication;
determining which communications network the device is registered with; and
with a proviso that the second node determines the device is roaming, from the first communications network in the second communications network, refraining from sending a request to receive the notification indicating the exposure to the event to a fourth node in the second communications network; and
sending a third indication to the first node, the third indication indicating whether or not the device is roaming, and the third indication being based on the sent second indication.

13. (canceled)

14. The computer-implemented method according to claim 12, wherein with a proviso that the third node lacks permission for roaming exposure, the second indication explicitly indicates the third node lacks permission for roaming exposure, and the third indication indicates the device is roaming and lacks permission to receive the notification.

15. The computer-implemented method according to claim 12, wherein with a proviso that the third node has permission to receive the notification indicating the exposure to the event while roaming in a first subset of the one or more roaming communications networks, the first subset having a number of networks lower than a first threshold, the second indication indicates at least one of:
the third node has permission to receive the notification indicating the exposure to the event while roaming in at least one of:
the first subset, as explicitly indicated;
the first subset, as pre-configured at the second node; and
any communications network where the device is allowed to register for roaming; and
a first request for the second node to perform re-authorization of whether or not the third node has permission to receive the notification with a proviso that the device roams into a different communications network; and
wherein the third indication indicates at least one of:
the received request to receive the notification about the exposure of the event for the device has been successful;
the device is roaming in the second communications network; and
the device is roaming and lacks permission to receive the notification in the second communications network.

16. The computer-implemented method according to claim 15, wherein one of:
with a proviso that the second indication lacks the first request to perform re-authorization, the second node stores the second indication and the determining further comprises determining whether the communications network the device is registered with is allowed for exposure;
with a proviso that the second indication comprises the first request to perform re-authorization, the storing comprises storing at least one of: the first request and the first subset, and the method further comprises: performing re-authorization with the first node of whether or not the third node has permission to receive the notification with a proviso that the device roams into a different communications network;
with a proviso that the second indication indicates the third node has permission to receive the notification while roaming in the first subset, as pre-configured at the second node or in any communications network where the device is allowed to register for roaming, the second node refrains from performing the re-authorization; and
with a proviso that the second indication only comprises the first request to perform re-authorization, the storing comprises storing the first request and second node performs the re-authorization.

17. The computer-implemented method according to claim 12, wherein with a proviso that the third node has permission to receive the notification indicating the exposure to the event while roaming in a second subset of the one or more roaming communications networks, the second subset having a number of networks exceeding a second threshold, the second indication indicates an indicator of an endpoint in the first node the second node is to use to perform re-authorization with the first node of whether or not the third node has permission to receive the notification indicating the exposure to the event while the device is roaming in the second communications network, the second communications network being comprised in the second subset, and wherein the re-authorization is to be performed with a proviso that the device roams into a different communications network.

18. The computer-implemented method according to claim 17, wherein the second indication further indicates a first request for the second node to perform the re-authorization.

19. The computer-implemented method according to claim 15, wherein the third indication indicates one of:
the device is roaming in the second communications network; and
the received request to receive the notification about the exposure of the event for the device has been successful.

20. The computer-implemented method according to claim 19, wherein the third indication indicates the device is roaming in the second communications network and a first identifier of the second communications network, and wherein the method further comprises:
receiving a fifth indication from the first node, based on the sent third indication, the fifth indication indicating whether or not the third node has permission to receive the notification, wherein the fifth indication is based on the one or more agreements.

21. The computer-implemented method according to claim 12, wherein the first node is a Network Exposure Function, NEF, the third node is an Application Function, AF, and the second node is a Unified Data Management, UDM.

22. The computer-implemented method according to claim 12, wherein the one or more agreements to receive service are one or more Service Level Agreements, SLAs.

23. (canceled)

24. A first node, for handling exposure to an event for a device, the first node being configured to operate in a first communications network, the first communications network being configured to be a home network to the device and to a second node, the first node being further configured to:
determine whether or not a third node configured to operate in a communications system via the first communications network has permission to receive notifications of the event while the device is roaming in a second communications network, the determining being configured to be performed in response to a first indication configured to be received from the third node indicating a request to receive a notification of the event for the device, and the determining being configured to be based on one or more agreements of the third node with the first communications network to service the device in one or more roaming communications networks;
send a second indication to the second node configured to operate in the first communications network, the second indication being configured to indicate a result of the determination;
receive a third indication from the second node, the third indication indicating whether or not the device is roaming, and the third indication being based on the sent second indication; and
send a fourth indication to the third node, the fourth indication being based on the received third indication, the fourth indication indicating whether or not the device is roaming, and whether or not the third node has permission to receive the notification.

25.-34. (canceled)

35. A second node, for handling exposure to an event for a device, the second node being configured to operate in a first communications network, the first communications network being configured to be a home network to the device, the second node being further configured to:
receive a second indication from a first node configured to operate in the first communications network, the second indication being configured to indicate whether or not a third node configured to operate in a communications system via the first communications network has permission to receive notifications of the event while the device is roaming in a second communications network, the second indication being dependent on a response to a first indication received by the first node from the third node indicating a request to receive a notification of the event for the device, the second indication being configured to operate based on one or more agreements of the third node with the first communications network to service the device in one or more roaming communications networks;
store the second indication;
determine which communications network the device is registered with;
with a proviso that the second node determines the device is roaming, from the first communications network in the second communications network, the second node further being configured to refrain from sending a request to receive the notification indicating the exposure to the event to a fourth node in the second communications network; and
send a third indication to the first node, the third indication being configured to indicate whether or not the device is roaming, and the third indication being configured to be based on the second indication configured to be sent.

36.-46. (canceled)
